(19) United States
(12) Patent Application Publication
(10) Pub. No.: US 2026/0148092 A1
(43) Pub. Date: May 28, 2026

(54) SPARSE 1-BIT QUANTIZATION-BASED OVER-THE-AIR FEDERATED LEARNING METHOD AND SYSTEM

(71) Applicant: CHUNG ANG UNIVERSITY INDUSTRY ACADEMIC COOPERATION FOUNDATION, Seoul (KR)

(72) Inventors: Sung Rae CHO, Seongnam-si (KR); Dong Hyun LEE, Seoul (KR); Jun Suk OH, Seoul (KR)

(21) Appl. No.: 19/086,841

(22) Filed: Mar. 21, 2025

(30) Foreign Application Priority Data
Nov. 27, 2024 (KR) 10-2024-0172619

(51) Int. Cl. G06N 3/098

(52) U.S. Cl. CPC G06N 3/098

(57) ABSTRACT

Sparse 1-bit quantization-based over-the-air federated learning method and system are disclosed. The A sparse 1-bit quantization-based over-the-air federated learning method, comprising: receiving a global parameter vector from a server at each communication round t and updating a local parameter vector using the global gradient vector; deriving a local gradient vector by applying a first-order approximation algorithm using a local dataset, compressing the local gradient vector through 1-bit quantization for each layer, and then sparsifying the 1-bit quantized local gradient vector; and transmitting the sparsified 1-bit quantized local gradient vector to the server through the uplink channel in an analog manner, the server calculates the global gradient vector using the signal aggregated in the air of the sparsified 1-bit quantized local gradient vectors and then broadcasts the global gradient vector to all devices.

### CROSS-REFERENCE TO RELATED APPLICATION

This application claims the benefit of priority under 35 U.S.C. § 119(a) to Korean Patent Application No. 10-2024-0172619, filed on Nov. 27, 2024, with the Korean Intellectual Property Office, the entire contents of which is incorporated herein by reference.

### BACKGROUND

### (a) Technical Field

The present disclosure relates to a sparse 1-bit quantization-based over-the-air federated learning method and system.

### (b) Background Art

Machine Learning (ML), which has proliferated in recent years, provides various application services through big data. However, centralized data center learning faces privacy challenges because a parameter server (PS) collects data generated on each device.

Federated Learning (FL) is a ML paradigm that has emerged to address these issues and aims to train a single global learning model using data stored on numerous local devices, based on adjustments of the PS. FL repeats communication rounds in which the local gradients of trained local learning models are aggregated until the global learning model converges. Thus, raw data are not collected therefore, FL offers an opportunity to leverage the computational resources of each device while protecting privacy, unlike centralized data center learning.

In FL, all types of learning models can be selected depending on the provided application services. However, in Fl, excessive communication costs can arise due to the numerous parameters that make up the learning model, leading to bottlenecks. For example, to provide image classification services, one must choose artificial neural networks such as ResNet-152 with 6.3 million parameters or VGG-16 with 138 million parameters. Therefore, in FL, gradient compression methods are considered to reduce communication costs per device. Quantization is a system that limits each parameter in the local gradient to be represented by a finite number of bits. Sparsification is a system that removes some parameters from the local gradient and retains only the important parameters.

The hybrid system is a system that combines quantization and sparsification. Information loss due to local gradient compression can lead to errors in global gradient estimation, which in turn causes a degradation in convergence rate and learning performance. Therefore, gradient compression systems tend to integrate an error feedback mechanism in the next communication round to compensate for this information loss.

Despite the gradient compression system, FL is still faced with bottlenecks because communication costs are influenced by the number of devices participating in each communication round. Therefore, FL has recently evolved into FLOA (FL Over-the-Air) by integrating Over-the-Air Computation (OAC), which utilizes the waveform superposition characteristics of the Multiple Access Channel (MAC) to transform the air into a computer performing both computing and communication functions.

In FLOA, all devices transmit local gradients simultaneously over the same time-frequency resources, and the PS can receive the result of these local gradients being aggregated analogically in the air. Therefore, FLOA integrates communication and computation to achieve higher bandwidth efficiency than traditional FL. FLOA can address the issue where communication costs increase linearly with the number of devices participating in each communication round in relation to high communication costs. However, it has not yet resolved the issue of increasing communication costs based on the number of parameters in the learning model. Additionally, FLOA still faces the typical problem of OAC, where the signals transmitted by each device can be distorted by noise and fading.

Therefore, numerous previous studies have focused on gradient compression systems and power control techniques to reduce communication costs and mitigate signal distortion. Gradient compression systems and power control techniques that can control compression and aggregation errors have a significant impact on the performance of the learning model. However, existing studies have a problem in that they adopt a fixed compression rate regardless of the channel conditions, making it impossible to optimally control these compression and aggregation errors.

### SUMMARY OF THE DISCLOSURE

The present disclosure provides a sparse 1-bit quantization-based over-the-air federated learning method and system.

Additionally, the present disclosure can provide a new compression and transmission-enabled sparse 1-bit quantization-based over-the-air federated learning method and system that performs joint optimal power and error control based on sparsification-based compression ratio dynamic control.

According to an aspect of the present invention, there is provided a sparse 1-bit quantization-based over-the-air federated learning method.

According to an embodiment of the present disclosure, there may be provided a sparse 1-bit quantization-based over-the-air federated learning method, comprising: receiving a global parameter vector from a server at each communication round t and updating a local parameter vector using the global gradient vector; deriving a local gradient vector by applying a first-order approximation algorithm using a local dataset, compressing the local gradient vector through 1-bit quantization for each layer, and then sparsifying the 1-bit quantized local gradient vector; and transmitting the sparsified 1-bit quantized local gradient vector to the server through the uplink channel in an analog manner, the server calculates the global gradient vector using the signal aggregated in the air of the sparsified 1-bit quantized local gradient vectors and then broadcasts the global gradient vector to all devices.

The step of compressing through 1-bit quantization and then sparsifying for each layer, further comprising: calculating the local gradient vector magnitude scaling factor for each layer; and calculating the sparsified 1-bit quantized the local gradient vector using the calculated magnitude scaling factor and layer-specific sparse masking indicator.

According to another embodiment of the present disclosure, a sparse 1-bit quantization-based over-the-air federated learning method includes: (a) determining an amplitude scaling factor and binary sparse masking indicator by considering the loss function and constraints at each communication round, and transmitting the amplitude scaling factor and binary sparse masking indicators to each device; (b) receiving signal—the signal is the signal aggregated in the air of the sparsified 1-bit quantized local gradient vectors from each device; (c) calculating a global gradient vector by correcting the received signal based on the amplitude scaling factors and the sum of all local dataset sizes; and (d) broadcasting the global gradient vector.

According to another aspect of the present disclosure, there is provided a device for performing a sparse 1-bit quantization-based over-the-air federated learning method.

According to an embodiment of the present disclosure, there may be provided a device for performing a sparse 1-bit quantization-based over-the-air federated learning method, comprising: a memory storing at least one command; and a processor executing commands stored in the memory, wherein the commands executed by the processor respectively perform: receiving a global parameter vector from a server at each communication round t and updating a local parameter vector using the global gradient vector; deriving a local gradient vector by applying a first-order approximation algorithm using a local dataset, compressing the local gradient vector through 1-bit quantization for each layer, and then sparsifying the 1-bit quantized local gradient vector; and transmitting the sparsified 1-bit quantized local gradient vector to the server through the uplink channel in an analog manner, the server calculates the global gradient vector using the signal aggregated in the air of the sparsified 1-bit quantized local gradient vectors and then broadcasts the global gradient vector.

According to another embodiment of the present disclosure, there may be provided A server for performing a sparse 1-bit quantization-based over-the-air federated learning method, comprising: a memory storing at least one command; and a processor executing commands stored in the memory, wherein the commands executed by the processor respectively perform: (a) determining an amplitude scaling factor and binary sparse masking indicator by considering the loss function and constraints at each communication round, and transmitting the amplitude scaling factor and binary sparse masking indicators to each device; (b) receiving signal—the signal is the signal aggregated in the air of the sparsified 1-bit quantized local gradient vectors from each device; (c) calculating a global gradient vector by correcting the received signal based on the amplitude scaling factors and the sum of all local dataset sizes; and (d) broadcasting the global gradient vector.

### BRIEF DESCRIPTION OF DRAWINGS

FIG. 1 is a diagram schematically illustrating the system configuration for performing a sparse 1-bit quantization-based over-the-air federated learning method according to an embodiment of the present disclosure.

FIG. 2 is a diagram showing pseudocode for a decomposition-based feasible solution according to an embodiment of the present disclosure.

FIG. 3 is a flowchart illustrating a sparse 1-bit quantization-based federated learning method performed on each device according to an embodiment of the present disclosure.

FIG. 4 is a flowchart illustrating a sparse 1-bit quantization-based over-the-air federated learning method performed on server according to an embodiment of the present disclosure.

FIG. 5 is a diagram illustrating preliminary experimental results based on the dataset.

FIG. 6 is a diagram showing the experimental parameter settings according to an embodiment of the present disclosure.

FIG. 7 is a diagram evaluating learning performance in an error-free channel according to the conventional method and an embodiment of the present disclosure.

FIG. 8 is a diagram evaluating learning performance in a fading channel according to the conventional method and an embodiment of the present disclosure.

FIG. 9 is a diagram comparing communication efficiency according to the conventional method and an embodiment of the present disclosure.

FIG. 10 is a diagram comparing the impact of device groups according to the conventional method and an embodiment of the present disclosure.

FIG. 11 is a diagram comparing the impact of network conditions according to the conventional method and an embodiment of the present disclosure.

FIG. 12 is a diagram illustrating the internal configuration of the device/server according to an embodiment of the present disclosure.

### DETAILED DESCRIPTION

Singular forms used in this specification include plural forms unless the context clearly indicates otherwise. In the specification, the term “configured”, “include”, or the like should not be construed as necessarily including several components or several steps described herein, in which some of the components or steps may not be included or additional components or steps may be further included. Further, the terms “˜ unit”, “module”, and the like mean a unit for processing at least one function or operation and may be implemented by hardware or software or by a combination of hardware and software.

Hereinafter, the embodiments of the present disclosure will be described in detail with reference to the accompanying drawings.

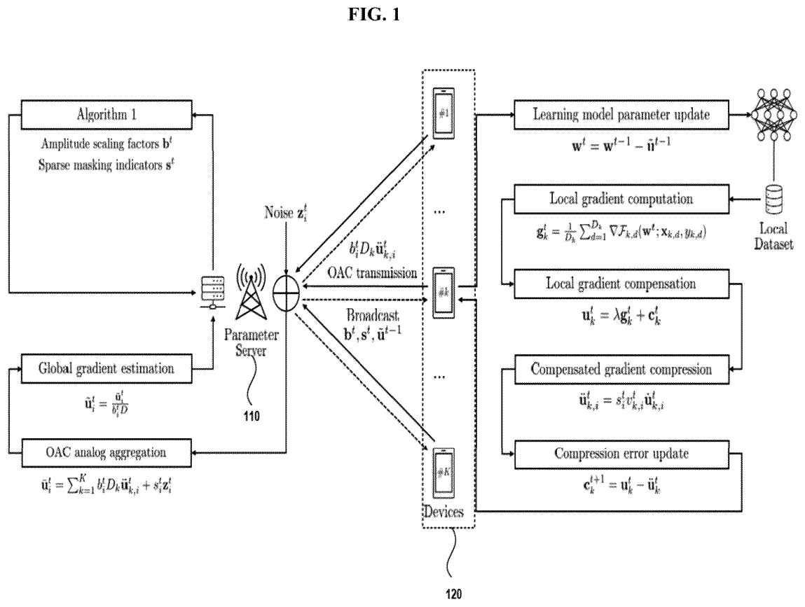

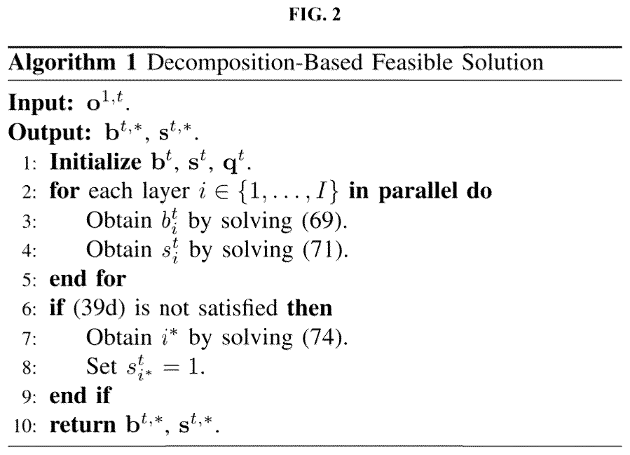

FIG. 1 is a diagram schematically illustrating the system configuration for performing a sparse 1-bit quantization-based over-the-air federated learning method according to an embodiment of the present disclosure, and FIG. 2 is a diagram showing pseudocode for a decomposition-based feasible solution according to an embodiment of the present disclosure.

As shown in FIG. 1, the system according to an embodiment of the present disclosure is a wireless network-based FL system composed of a single server (110) and K devices (120).

For the sake of understanding and ease of explanation, the system's learning model will be explained first.

### The System Learning Model

In the FL system, device k has its local dataset consisting of Dₖ data samples. For training the learning model, the local loss function [symbol] ₖ(⋅) with the parameter vector w can define as Equation 1.

$${ℱ}_{k} ( w ) = \frac{1}{{D}_{k}} {\sum }_{d = 1}^{{D}_{k}} {ℱ}_{k , d} ( w ; {x}_{k , d} , {y}_{k , d} ) , \qquad [ Equation 1 ]$$

Where [symbol] _{k,d}(⋅) represents the loss function of sample d, which consists of a feature vector x_{k,d} and a label [symbol] _{k,d}. Based on the local loss functions [symbol] ₖ(⋅) of all devices, the global loss function [symbol] (⋅) with w can be defined as shown in Equation 2.

$$ℱ ( w ) = \frac{1}{D} {\sum }_{d = 1}^{{D}_{k}} {D}_{k} {ℱ}_{k} ( w ) \qquad [ Equation 2 ]$$

Where, D can be defined as

$${\sum }_{k = 1}^{K} {D}_{k} .$$

Therefore, the FL system can aim to determine an optimal parameter vector w* by minimizing the global loss function [symbol] (⋅) as shown in Equation 3.

$$P 1 : {w}^{*} = arg {min}_{w} ℱ ( w ) \qquad [ Equation 3 ]$$

FL system is configured in a distributed manner for the training process between the server (110) and the devices, such that raw samples are not directly transmitted from each device to the server (110). That is, the server (110) does not collect the raw samples from each device.

In each communication round t∈{1, . . . , T}, each device can update the parameter vector w^{t} based on its local dataset using the first approximation algorithm in order to minimize the local loss function and derive the local gradient vector

$${g}_{k}^{t} ,$$

as shown in Equation 4.

$${g}_{k}^{t} = \frac{1}{{D}_{k}} {\sum }_{d = 1}^{{D}_{k}} ∇ {ℱ}_{k , d} ( {w}^{t} ; {x}_{k , d} , {y}_{k , d} ) , \qquad [ Equation 4 ]$$

Where, ∇ [symbol] _{k,d}(⋅) represents the gradient of [symbol] _{k,d}(⋅) with respect to w^{t}.

Each device can transmit the derived local gradient vector

$${g}_{k}^{t}$$

to server (110), and the server (110) can aggregate the local gradient vector

$${g}_{k}^{t}$$

transmitted from each device and derive the global gradient vector g^{t}, as shown in Equation 5.

$${g}^{t} = \frac{1}{D} {\sum }_{k = 1}^{K} {D}_{k} {g}_{k}^{t} \qquad [ Equation 5 ]$$

Once the global gradient vector is derived, the server (110) can broadcast the global gradient vector, and each device can update the parameter w^{t}, as shown in Equation 6.

$${w}^{t + 1} = {w}^{t} - λ {g}^{t} \qquad [ Equation 6 ]$$

Where, λ represents the learning rate.

The FL system can iterate the FL training process including Equation 4 to Equation 6 until the convergence condition is satisfied or the maximum communication round T is reached.

We will explain now a compression model of each device.

### The Compression Model

According to an embodiment of the present discourse, a layer-wise scaled one-bit quantization and layer-wise sparsification are used for efficient FL. However, the aggressive gradient compression degrades the convergence rate and learning performance. Thus, FL system can incorporate the error-feedback mechanism to mitigate the negative effect of the compression error.

Each device can divide the local gradient vector into blocks (sub-vectors) and derive the gradient magnitude scaling factor block-wise, which is average of the parameters within the block. However, if a block consists of parameters of different layers, and the parameter magnitudes between layers differ significantly, the gradient magnitude scaling factor of that block may not accurately indicate its importance. Therefore, layers can be considered as blocks.

In each communication round t, each device can derive the compensated local gradient vector

$${u}_{k}^{t}$$

by adding a compression error vector

$${c}_{k}^{t} ,$$

as shown in Equation 7.

$${u}_{k}^{t} = λ {g}_{k}^{t} + {c}_{k}^{t} \qquad [ Equation 7 ]$$

Where,

$${c}_{k}^{t}$$

can compensate for information loss caused by gradient compression in the previous round. Then, each device can derive the magnitude scaling factor

$${v}_{k , i}^{t}$$

layer-wise, as shown in Equation 8.

$${v}_{k , i}^{t} = \frac{1}{{J}_{i}} {‖ {u}_{k , i}^{t} ‖}_{1} \qquad [ Equation 8 ]$$

Where, i∈{1, . . . , I} represents a layer i.

In addition, each device can derive a quantized

$${u}_{k}^{t}$$

for each parameter, as shown in Equation 9.

$${\dot{u}}_{k , i , j}^{t} = \{ \begin{matrix}+ 1 , & {u}_{k , i , j}^{t} \geq 0 , \\ - 1 , & otherwise\end{matrix} , \qquad [ Equation 9 ]$$

Where, j∈{1, . . . , Jᵢ} represents the parameter j of the layer i. Thus, the compressed

$${u}_{k}^{t}$$

can be defined as shown in Equation 10.

$${\ddot{u}}_{k , i}^{t} = {s}_{i}^{t} {v}_{k , i}^{t} {\dot{u}}_{k , i}^{t} \qquad [ Equation 10 ]$$

Where,

$${s}_{i}^{t}$$

represents a sparse masking indicator and in each communication round t, if the layer i is not transmitted,

$${s}_{i}^{t} = 0 , otherwise {s}_{i}^{t} = 1.$$

Thus, a compression error vector

$${c}_{k}^{t}$$

can be updated as shown in Equation 11.

$${c}_{k}^{t + 1} = {u}_{k}^{t} - {\ddot{u}}_{k}^{t} \qquad [ Equation 11 ]$$

Where,

$${c}_{k}^{t + 1}$$

is locally stored on device k. Aggregating layers with small gradients does not significantly improve the test accuracy and only increases communication costs. Therefore, by transmitting only a few layers with high gradients, it is possible to reduce costs while maintaining test accuracy compared to transmitting all layers.

According to an embodiment of the present discourse, the layer-wise sparsification operates in a synchronized manner where the same specific layers across all devices are sparsified for each round, the averaged gradient information of the server (110) can be transmitted without losing sparsity to the downlink. It can reduce the amount of downlink traffic and enhance the drop-out effect in terms information abstraction in the learning model.

### Aggregation Model

In each communication round t, when each device transmits

$${\ddot{u}}_{k , i}^{t} ,$$

the server (110) can aggregate them layer-wise and derive

$${\ddot{u}}_{i}^{t}$$

as shown in Equation 12.

$${\ddot{u}}_{i}^{t} = \frac{1}{D} {{\sum }_{k = 1}}^{K} {D}_{k} {\ddot{u}}_{k , i}^{t} \qquad [ Equation 12 ]$$

However,

$${\ddot{u}}_{k , i}^{t}$$

is transmitted in an analog manner and aggregated in the air, so the signal sub vector

$${\overline{u}}_{i}^{t} .$$

received at the server (110) is given by Equation 13.

$${\overline{u}}_{i}^{t} = {{\sum }_{k = 1}}^{K} {h}_{k}^{t} {p}_{k , i}^{t} {\ddot{u}}_{k , i}^{t} + {s}_{i}^{t} {z}_{i}^{t} \qquad [ Equation 13 ]$$

Where,

$${h}_{k}^{t}$$

represents a channel coefficient between the device k and the server (110), which is generated at [symbol] (0,1) and can be modeled as independent and identically distributed (I.I.D.) Rayleigh fading.

It is assumed that perfect uplink channel state information (CSI) is available, and the CSI of the block fading channel does not change within each round t, but can change independently across different rounds.

In addition,

$${p}_{k , i}^{t} .$$

represents a transmission power,

$${z}_{i}^{t}$$

represents an AWGN (Additive White Gaussian Noise) sub-vector,

$${z}_{i , j}^{t}$$

can be generated from [symbol] (0,σ²) of noise power σ².

In order to ensure that Equation 13 can be approximated to Equation 12 as closely as possible by mitigating the signal distortion caused by noise and fading,

$${p}_{k , i}^{t}$$

can be designed as shown in Equation 14.

$${p}_{k , i}^{t} = \frac{{b}_{i}^{t} {D}_{k}}{{h}_{k}^{t}} \qquad [ Equation 14 ]$$

Where,

$${b}_{i}^{t}$$

represents a (power) amplitude scaling factor. Therefore, each device must meet the transmission power constraint as shown in Equation 15.

$${\vert {p}_{k , i}^{t} {\ddot{u}}_{k , i , j}^{t} \vert}^{2} = {\vert \frac{{b}_{i}^{t} {D}_{k} {s}_{i}^{t} {v}_{k , i}^{t}}{{h}_{k}^{t}} \vert}^{2} \leq P ; \qquad [ Equation 15 ]$$

Where, P represents a maximum transmission power,

$${\dot{u}}_{k , i , j}^{t}$$

can be eliminated because of

$$\text{?} = \pm 1 \text{?}$$

$$\text{?} \text{indicates text missing or illegible when filed}$$

By substituting Equation 14 into Equation 13,

$$\text{?}$$

$$\text{?} \text{indicates text missing or illegible when filed}$$

can be rewritten as shown in Equation 16.

$${\overline{u}}_{i}^{t} = {\sum }_{k = 1}^{K} {b}_{i}^{t} {D}_{k} \text{?} + {s}_{i}^{t} {z}_{i}^{t} \qquad [ Equation 16 ]$$

$$\text{?} \text{indicates text missing or illegible when filed}$$

Where,

$${b}_{i}^{t} {D}_{k}$$

represents the pre-processing factor. Upon

$$\text{?}$$

$$\text{?} \text{indicates text missing or illegible when filed}$$

the server (110) can derive the estimated

$$\text{?}$$

$$\text{?} \text{indicates text missing or illegible when filed}$$

as shown in Equation 17.

$$\text{?} = \text{?} = \text{?} + \text{?} \qquad [ Equation 17 ]$$

$$\text{?} \text{indicates text missing or illegible when filed}$$

Where,

$${b}_{i}^{t} D$$

represents the post-processing factor. The server (110) can broadcast ũ^{t} to all devices and update the parameter vector as shown in Equation 18.

$${w}^{t + 1} = {w}^{t} - {\tilde{u}}^{t} \qquad [ Equation 18 ]$$

All devices can receive perfect ũ^{t} through error-free downlink channels by the high transmission power and bandwidth of the server (110).

The following widely adopted assumptions are made regarding the compression operator, loss function, and gradient vector for convergence rate analysis.

### Assumption 1: A Compression Operator

The operator [symbol] (⋅): [symbol] ^{J}→ [symbol] ^{J.} represents a δ-approximate compression [symbol] operator with approximation factor δ∈[0,1], as shown in Equation 19.

$${‖ 𝒞 ( u ) - u ‖}_{2}^{2} \leq ( 1 - δ ) {‖ u ‖}_{2}^{2} , ∀ u ∈ {ℝ}^{J}$$

Where,

$$J = {\sum }_{i = 1}^{I} {J}_{i} ,$$

it can be extended in the layer-wise form as shown in Equation 20.

$$\begin{matrix}{‖ 𝒞 ( {u}_{i} ) - {u}_{i} ‖}_{2}^{2} = {‖ {s}_{i} {v}_{i} \text{?} - {u}_{i} ‖}_{2}^{2} \\ = {J}_{i} {{s}_{i} ( {v}_{i} )}^{2} - 2 {s}_{i} {v}_{i} {‖ {u}_{i} ‖}_{1} + {‖ {u}_{i} ‖}_{2}^{2} \\ = ( 1 - \frac{{J}_{i} {{s}_{i} ( {v}_{i} )}^{2}}{{‖ {u}_{i} ‖}_{2}^{2}} ) {‖ {u}_{i} ‖}_{2}^{2} \\ \leq ( 1 - {s}_{i} δ ) {‖ {u}_{i} ‖}_{2}^{2} , ∀ i .\end{matrix} \qquad [ Equation 20 ]$$

$$\text{?} \text{indicates text missing or illegible when filed}$$

### Assumption 2: Loss Function Bound

The global loss function [symbol] (⋅) is lower-bounded by an optimal parameter vector w* for the given parameter vector w.

$$ℱ ( w ) \geq ℱ ( \text{?} ) , ∀ w ∈ {ℝ}^{J}$$

$$\text{?} \text{indicates text missing or illegible when filed}$$

### Assumption 3: Smoothness and Lipschitz Continuity

The global loss function [symbol] (⋅) is L-smooth and the corresponding gradient vector ∇ [symbol] (⋅) is L-Lipschitz continuous, that is as shown in Equation 22.

$$\vert ℱ ( {w}^{′} ) - ( ℱ ( w ) + ∇ ℱ \text{?} ( {w}^{′} - w ) ) \vert \leq \frac{L}{2} {‖ {w}^{′} - w ‖}_{2}^{2} , \text{} ∀ {w}^{′} , \text{} w ∈ {ℝ}^{J} , \qquad [ Equation 22 ]$$

$$\text{?} \text{indicates text missing or illegible when filed}$$

Where, L represents a non-negative constant. Equation 22 can be expressed as Equation 23.

$${‖ ∇ ℱ ( {w}^{′} ) - ∇ ℱ ( w ) ‖}_{2} \leq L {‖ {w}^{′} - w ‖}_{2} \qquad [ Equation 23 ]$$

### Assumption 4: Gradient Vector Bound

The local gradient vector gₖ is an independent and unbiased estimate of the global gradient vector [symbol] [g]=∇ [symbol] (w)

$${‖ {g}_{k} ‖}_{2}^{2} \leq {G}^{2} , ∀ k \qquad [ Equation 24 ]$$

Where, G represents a positive constant, it is extended in the layer-wise form as shown in Equation 25.

$${‖ {g}_{k , i} ‖}_{2}^{2} \leq {G}_{i}^{2} , ∀ i \qquad [ Equation 25 ]$$

### Lemma 1

In the FL system, to explain compression error caused by layer-wise scaled one-bit quantization, layer-wise sparsification, and the error-feedback mechanism, Lemma 1, which defines the bound on the compression error based on Assumption 1 and Assumption 4, can be derived as shown in Equation 26.

$$𝔼 {‖ \frac{1}{D} {\sum }_{k = 1}^{K} {D}_{k} {c}_{k}^{t + 1} ‖}_{2}^{2} \leq {\sum }_{i = 1}^{I} \frac{( 1 - {s}_{i}^{t} δ ) ( 2 - δ ) {λ}^{2} {G}_{i}^{2}}{δ} \times ( {( t - {S}_{i} )}^{2} + \frac{( 2 - δ ) {M}_{i}^{2}}{δ} ) \qquad [ Equation 26 ]$$

Where, Sᵢ represents a most recent communication round t with

$${s}_{i}^{t} = 1.$$

In addition, Mᵢ≥1 is the maximum non-transmission period (t−Sᵢ≤Mᵢ). According to Equation 7, Equation 11 and Assumption 1, the bound on the compression error

$${c}_{k}^{t + 1}$$

can be derived layer by layer as shown in Equation 27.

$${‖ {c}_{k}^{t + 1} ‖}_{2}^{2} = {‖ 𝒞 ( {u}_{k , i}^{t} ) - {u}_{k , i}^{t} ‖}_{2}^{2} \leq ( 1 - {s}_{i}^{t} δ ) {‖ {u}_{k , i}^{t} ‖}_{2}^{2} = ( 1 - {s}_{i}^{t} δ ) {‖ {\sum }_{τ = {S}_{i} + 1}^{t} {λg}_{k}^{τ} + {c}_{k}^{{S}_{i} + 1} ‖}_{2}^{2} \qquad [ Equation 27 ]$$

Since there is a recursive relationship in Equation 27, Equation 28 can be derived using the Perter-Paul inequality with any η>0, Jensen's inequality, and Assumption 4.

$${‖ {c}_{k , i}^{t + 1} ‖}_{2}^{2} \leq ( 1 - {s}_{i}^{t} δ ) {‖ {\sum }_{τ = {S}_{i} + 1}^{t} {λg}_{k}^{τ} + {c}_{k}^{{S}_{i} + 1} ‖}_{2}^{2} \leq ( 1 - {s}_{i}^{t} δ ) ( 1 + 1 / η ) {‖ {\sum }_{τ = {S}_{i} + 1}^{t} {λg}_{k}^{τ} ‖}_{2}^{2} + ( 1 - {s}_{i}^{t} δ ) ( 1 + η ) {‖ {c}_{k , i}^{{S}_{i} + 1} ‖}_{2}^{2} \leq ( 1 - {s}_{i}^{t} δ ) ( 1 + 1 / η ) {( t - {S}_{i} )}^{2} {λ}^{2} {G}_{i}^{2} + ( 1 - {s}_{i}^{t} δ ) ( 1 + η ) {‖ {c}_{k , i}^{{S}_{i} + 1} ‖}_{2}^{2} . \qquad [ Equation 28 ]$$

To solve the recurrence relation, the memory mᵢ∈{0, . . . , Sᵢ} can be defined that stores all Sᵢ from the past to the present. The Equation 29 can be derived by applying Equation 27 and Equation 28 to all communication rounds stored in mᵢ.

$$𝔼 {‖ {c}_{k , i}^{t + 1} ‖}_{2}^{2} \leq ( 1 - {s}_{i}^{t} δ ) ( 1 + 1 / η ) {( t - {S}_{i} )}^{2} {λ}^{2} {G}_{i}^{2} + ( 1 - {s}_{i}^{t} δ ) ( 1 + η ) 𝔼 {‖ {c}_{k , i}^{{S}_{i} + 1} ‖}_{2}^{2} \leq ( 1 - {s}_{i}^{t} δ ) ( 1 + 1 / η ) {( t - {S}_{i} )}^{2} {λ}^{2} {G}_{i}^{2} + ( 1 - {s}_{i}^{t} δ ) ( 1 + η ) ( 1 - δ ) ( 1 + 1 / η ) {λ}^{2} {G}_{i}^{2} \times {\sum }_{n = 2}^{{N}_{i}} {( ( 1 - δ ) ( 1 + η ) )}^{{N}_{i} - n} {( {m}_{i , n} - {m}_{i , n - 1} )}^{2} \leq ( 1 - {s}_{i}^{t} δ ) ( 1 + 1 / η ) {( t - {S}_{i} )}^{2} {λ}^{2} {G}_{i}^{2} + ( 1 - {s}_{i}^{t} δ ) ( 1 + η ) ( 1 - δ ) ( 1 + 1 / η ) {λ}^{2} {M}_{i}^{2} {G}_{i}^{2} \times {\sum }_{n = 2}^{∞} {( ( 1 - δ ) ( 1 + η ) )}^{n - 2} = ( 1 - {s}_{i}^{t} δ ) ( 1 + 1 / η ) {( t - {S}_{i} )}^{2} {λ}^{2} {G}_{i}^{2} + \frac{( 1 - {s}_{i}^{t} δ ) ( 1 + η ) ( 1 - δ ) ( 1 + 1 / η ) {λ}^{2} {M}_{i}^{2} {G}_{i}^{2}}{1 - ( 1 - δ ) ( 1 + η )} \leq \frac{1 - {s}_{i}^{t} δ ( 2 - δ ) {λ}^{2} {G}_{i}^{2}}{δ} \times ( {( t - {S}_{i} )}^{2} + \frac{( 2 - δ ) {M}_{i}^{2}}{δ} ) , \qquad [ Equation 29 ]$$

Where, n∈{1, . . . , Nᵢ} represents the address n, η can be set as

$$\frac{δ}{2 ( 1 - δ )} .$$

According to Jensen's inequality, it can be rearranged as shown in Equation 30.

$$𝔼 {‖ \frac{1}{D} {\sum }_{k = 1}^{K} {D}_{k} {c}_{k , i}^{t + 1} ‖}_{2}^{2} \leq \frac{1}{D} {\sum }_{k = 1}^{K} {D}_{k} 𝔼 {‖ {c}_{k , i}^{t + 1} ‖}_{2}^{2} = \frac{1}{D} {\sum }_{k = 1}^{K} {D}_{k} {\sum }_{i = 1}^{I} 𝔼 {‖ {c}_{k , i}^{t + 1} ‖}_{2}^{2} \leq {\sum }_{i = 1}^{I} \frac{( 1 - {s}_{i}^{t} δ ) ( 2 - δ ) {λ}^{2} {G}_{i}^{2}}{δ} \times ( {( t - {S}_{i} )}^{2} + \frac{( 2 - δ ) {M}_{i}^{2}}{δ} ) \qquad [ Equation 30 ]$$

### Lemma 2

In the FLOA system, to explain the aggregation error caused by analog aggregation, Lemma 2, which defines the aggregation error based on Equation 17 and the variance expression by expected value, can be derived as shown in Equation 31.

$$𝔼 {‖ {a}^{2} ‖}_{2}^{2} = {\sum }_{i = 1}^{I} 𝔼 {‖ \frac{{s}_{i}^{t} {z}_{i}^{t}}{{b}_{i}^{t} D} ‖}_{2}^{2} = {\sum }_{i = 1}^{I} \frac{{J}_{i} {s}_{i}^{t} {σ}^{2}}{{( {b}_{i}^{t} )}^{2} {D}^{2}} . \qquad [ Equation 31 ]$$

### Lemma 3

For convergence analysis of the sparse 1-bit quantization aggregation method according to an embodiment of the present disclosure, a non-compressed scenario is considered, where the actual parameter vector w^{t} is defined as an approximation of the ideal parameter vector ŵ^{t}, as shown in Equation 32.

$${\hat{w}}^{t} = {w}^{t} - \frac{1}{D} {\sum }_{k = 1}^{K} {D}_{k} {c}_{k}^{t} . \qquad [ Equation 32 ]$$

Lemma 3 defining the update of the ideal parameter vector ŵ^{t} can be derived as shown in Equation 33.

$${\hat{w}}^{t + 1} = {\hat{w}}^{t} - {λg}^{t} - {a}^{t} \qquad [ Equation 33 ]$$

Equation 33 can be proven by sequentially substituting Equation 18, Equation 17, Equation 11 and Equation 7 into Equation 32.

$$\begin{matrix}{\hat{w}}^{t + 1} = {w}^{t + 1} - \frac{1}{D} {\sum }_{k = 1}^{K} {D}_{k} {c}_{k}^{t + 1} \\ = {w}^{t} - {\overline{u}}^{t} - \frac{1}{D} {\sum }_{k = 1}^{K} {D}_{k} {c}_{k}^{t + 1} \\ = {w}^{t} - {\ddot{u}}^{t} - {a}^{t} - \frac{1}{D} {\sum }_{k = 1}^{K} {D}_{k} {c}_{k}^{t + 1} \\ = {w}^{t} - {u}^{t} - {a}^{t} \\ = {w}^{t} - {λg}^{t} - \frac{1}{D} {\sum }_{k = 1}^{K} {D}_{k} {c}_{k}^{t} - {a}^{t} \\ = {\hat{w}}^{t} - {λg}^{t} - {a}^{t}\end{matrix} . \qquad [ Equation 34 ]$$

### Theorem 1

Under Assumption 1-4 and Lemma 1-3, Theorem 1, which defines the convergence rate of the sparse one-bit analog aggregation with error-feedback mechanism (SOBBA-EFO) according to an embodiment of the present disclosure, can be derived as shown in Equation 35.

$$\frac{1}{T} {\sum }_{t = 1}^{T} {‖ ▽ℱ ( {w}^{t} ) ‖}_{2}^{2} \leq \frac{2 ( ℱ ( {w}^{1} ) - ℱ ( {w}^{*} ) )}{δλ𝒯} + \frac{{G}^{2}}{δ} + \frac{1}{T} {\sum }_{t = 1}^{T} {\sum }_{i = 1}^{I} \frac{{J}_{i} {s}_{i}^{t} {σ}^{2}}{{δ ( {b}_{i}^{t} )}^{2} {λ}^{2} {D}^{2}} + \frac{1}{T} {\sum }_{t = 1}^{T - 1} {\sum }_{i = 1}^{I} \frac{( 1 - {s}_{i}^{t} δ ) {G}_{i}^{2}}{{δ}^{2}} \times ( {( t - {S}_{i} )}^{2} + \frac{( 2 - δ ) {M}_{i}^{2}}{δ} ) \qquad [ Equation 35 ]$$

Based on Assumption 3, in each communication round, the global loss function [symbol] (⋅) with ŵ^{t+1} is bounded as shown in Equation 36.

$$ℱ ( {\hat{w}}^{t + 1} ) \leq ℱ ( {\hat{w}}^{t} ) + {( {\hat{w}}^{t + 1} - {\hat{w}}^{t} )}^{T} ∇ ℱ ( {\hat{w}}^{t} ) + \frac{L}{2} {‖ {\hat{w}}^{t + 1} - {\hat{w}}^{t} ‖}_{2}^{2} . \qquad [ Equation 36 ]$$

Furthermore, according to Assumption 4, Equation 36 can be bounded as shown in Equation 37.

$$[ Equation 37 ]$$

$$\begin{matrix}\text{} 𝔼 [ ℱ ( {\hat{w}}^{t + 1} ) ] \leq ℱ ( {\hat{w}}^{t} ) + {𝔼 [ ( {\hat{w}}^{t + 1} - {\hat{w}}^{t} ) ]}^{T} ∇ ℱ ( {\hat{w}}^{t} ) + \frac{L}{2} 𝔼 {‖ {\hat{w}}^{t + 1} - {\hat{w}}^{t} ‖}_{2}^{2} \\ = ℱ ( {\hat{w}}^{t} ) - {( λ 𝔼 [ ( {g}^{t} ) ] + 𝔼 [ {a}^{t} ] )}^{T} ∇ ℱ ( {\hat{w}}^{t} ) + \frac{L}{2} 𝔼 {‖ {\hat{w}}^{t + 1} - {\hat{w}}^{t} ‖}_{2}^{2} \\ = ℱ ( {\hat{w}}^{t} ) - λ ∇ {ℱ ( {w}^{t} )}^{T} ∇ ℱ ( {\hat{w}}^{t} ) + \frac{L}{2} 𝔼 {‖ {\hat{w}}^{t + 1} - {\hat{w}}^{t} ‖}_{2}^{2} \\ = ℱ ( {\hat{w}}^{t} ) - λ ∇ ℱ {( {w}^{t} )}^{T} ( ∇ ℱ ( {w}^{t} ) - ∇ ℱ ( {\hat{w}}^{t} ) ) \\ - λ {‖ ∇ ℱ ( {w}^{t} ) ‖}_{2}^{2} + \frac{L}{2} 𝔼 {‖ {\hat{w}}^{t + 1} - {\hat{w}}^{t} ‖}_{2}^{2} .\end{matrix}$$

The second term on the right-hand side of Equation 37 can be bounded as shown in Equation 38, according to the Peter-Paul inequality with any ρ>0 as shown in Equation 38.

$$[ Equation 38 ]$$

$$λ ∇ {ℱ ( {w}^{t} )}^{T} ( ∇ ℱ ( {w}^{t} ) - ∇ ℱ ( {\hat{w}}^{t} ) ) \leq \frac{λ ρ}{2} {‖ ∇ ℱ ( {w}^{t} ) ‖}_{2}^{2} + \frac{λ}{2 ρ} {‖ ∇ ℱ ( {w}^{t} ) - ∇ ℱ ( {\hat{w}}^{t} ) ‖}_{2}^{2}$$

The second term on the right-hand side (RHS) of Equation 38 can be bounded as shown in Equation 39, according to Assumption 3 and Lemma 1.

$$[ Equation 39 ]$$

$$\text{} \frac{λ}{2 ρ} {‖ ∇ ℱ ( {w}^{t} ) - ∇ ℱ ( {\hat{w}}^{t} ) ‖}_{2}^{2} \leq \frac{λ {L}^{2}}{2 ρ} {‖ {w}^{t} - {\hat{w}}^{t} ‖}_{2}^{2} = \frac{λ {L}^{2}}{2 ρ} {‖ \frac{1}{D} {\sum }_{k = 1}^{K} {D}_{k} {c}_{k}^{t} ‖}_{2}^{2} \leq {\sum }_{i = 1}^{I} \frac{( 1 - {s}_{i}^{t - 1} δ ) ( 2 - δ ) {λ}^{3} {L}^{2} {G}_{i}^{2}}{2 ρ δ} \times ( {( t - 1 - {S}_{i} )}^{2} + \frac{( 2 - δ ) {M}_{i}^{2}}{δ} )$$

Thus, the second term on the RHS of Equation 37 can be bounded as shown in Equation 40.

$$[ Equation 40 ]$$

$$λ ∇ {ℱ ( {w}^{t} )}^{T} ( ∇ ℱ ( {w}^{t} ) - ∇ ℱ ( {\hat{w}}^{t} ) ) \leq \frac{λ ρ}{2} {‖ ∇ ℱ ( {w}^{t} ) ‖}_{2}^{2} + {\sum }_{i = 1}^{I} \frac{( 1 - {s}_{i}^{t - 1} δ ) ( 2 - δ ) {λ}^{3} {L}^{2} {G}_{i}^{2}}{2 ρ δ} \times ( {( t - 1 - {S}_{i} )}^{2} + \frac{( 2 - δ ) {M}_{i}^{2}}{δ} ) .$$

Then, the last term on the RHS of Equation 37 can be bounded as shown in Equation 41, according to Jensen's inequality, Assumption 4 and Lemma 2.

$$\begin{matrix}\frac{L}{2} 𝔼 {‖ {\hat{w}}^{t + 1} - {\hat{w}}^{t} ‖}_{2}^{2} = \frac{{λ}^{2} L}{2} 𝔼 {‖ {g}^{t} ‖}_{2}^{2} + \frac{L}{2} 𝔼 {‖ {a}^{t} ‖}_{2}^{2} \\ = \frac{{λ}^{2} L}{2} 𝔼 {‖ \frac{1}{D} {\sum }_{k = 1}^{K} {D}_{k} {g}_{k}^{t} ‖}_{2}^{2} + \frac{L}{2} 𝔼 {‖ {a}^{t} ‖}_{2}^{2} \leq \\ \frac{{λ}^{2} L}{2 D} {\sum }_{k = 1}^{K} {D}_{k} 𝔼 {‖ {g}_{k}^{t} ‖}_{2}^{2} \leq + \frac{L}{2} 𝔼 {‖ {a}^{t} ‖}_{2}^{2} \leq \\ \frac{{λ}^{2} {LG}^{2}}{2} + \frac{L}{2} 𝔼 {‖ {a}^{t} ‖}_{2}^{2} \\ = \frac{{λ}^{2} {LG}^{2}}{2} + {\sum }_{i = 1}^{I} \frac{{J}_{i} {s}_{i}^{t} {σ}^{2} L}{2 {( {b}_{i}^{t} )}^{2} {D}^{2}} .\end{matrix} \qquad [ Equation 41 ]$$

By substituting Equation 40 and Equation 41 into Equation 37, it can be rearranged as shown in Equation 42.

$$[ Equation 42 ]$$

$$\text{} 𝔼 [ ℱ ( {\hat{w}}^{t + 1} ) ] \leq ℱ ( {\hat{w}}^{t} ) - λ ( 1 - \frac{ρ}{2} ) {‖ ∇ ℱ ( {w}^{t} ) ‖}_{2}^{2} + {\sum }_{i = 1}^{I} \frac{( 1 - {s}_{i}^{t - 1} δ ) ( 2 - δ ) {λ}^{3} {L}^{2} {G}_{i}^{2}}{2 ρ δ} \times ( {( t - 1 - {S}_{i} )}^{2} + \frac{( 2 - δ ) {M}_{i}^{2}}{δ} ) + \frac{{λ}^{2} {LG}^{2}}{2} + {\sum }_{i = 1}^{I} \frac{{J}_{i} {s}_{i}^{t} {σ}^{2} L}{2 {( {b}_{i}^{t} )}^{2} {D}^{2}} .$$

By rearranging the terms according to Assumption 2 and taking the average on both sides with respect to t, it can be expressed as shown in Equation 43.

$$[ Equation 43 ]$$

$$\text{} \frac{1}{T} {\sum }_{t = 1}^{T} {‖ ∇ ℱ ( {w}^{t} ) ‖}_{2}^{2} \leq \frac{2 ( ℱ ( {w}^{1} ) - ℱ ( {w}^{*} ) )}{( 2 - ρ ) λ T} + \frac{λ {LG}^{2}}{2 - ρ} + {\sum }_{t = 1}^{T} {\sum }_{i = 1}^{I} \frac{{J}_{i} {s}_{i}^{t} {σ}^{2} L}{( 2 - ρ ) {( {b}_{i}^{t} )}^{2} λ {D}^{2} T} + {\sum }_{t = 1}^{T - 1} {\sum }_{i = 1}^{I} \frac{( 1 - {s}_{i}^{t} δ ) ( 2 - δ ) {λ}^{2} {L}^{2} {G}_{i}^{2}}{( 2 - ρ ) ρ δ T} \times ( {( t - {S}_{i} )}^{2} + \frac{( 2 - δ ) {M}_{i}^{2}}{δ} ) .$$

Where, if L and ρ are set to 1/λ and 2−δ, respectively, for a simpler expression without compromising generality, it can be expressed as shown in Equation 44.

$$[ Equation 44 ]$$

$$\begin{matrix}\text{} \frac{1}{T} {\sum }_{t = 1}^{T} {‖ ∇ ℱ ( {w}^{t} ) ‖}_{2}^{2} \leq \frac{2 ( ℱ ( {w}^{1} ) - ℱ ( {w}^{*} ) )}{δ λ T} + \frac{{G}^{2}}{δ} + \frac{1}{T} {\sum }_{t = 1}^{T} {\sum }_{i = 1}^{I} \frac{{J}_{i} {s}_{i}^{t} {σ}^{2}}{{δ ( {b}_{i}^{t} )}^{2} {λ}^{2} {D}^{2}} + \\ \frac{1}{T} {\sum }_{t = 1}^{T - 1} {\sum }_{i = 1}^{I} \frac{( 1 - {s}_{i}^{t} δ ) {G}_{i}^{2}}{{δ}^{2}} \times ( {( t - {S}_{i} )}^{2} + \frac{( 2 - δ ) {M}_{i}^{2}}{δ} )\end{matrix}$$

To demonstrate the effect of the error-feedback mechanism based on Assumption 1 to 4 and Lemma 2, Theorem 2, which defines the convergence rate of the sparse one-bit analog aggregation without error-feedback mechanism (SOBBA-EFX) according to an embodiment of the present disclosure, can be derived as shown in Equation 45.

$$[ Equation 45 ]$$

$$\text{} \frac{1}{T} {\sum }_{t = 1}^{T} {‖ ∇ ℱ ( {w}^{t} ) ‖}_{2}^{2} \leq \frac{2 ( ℱ ( {w}^{1} ) - ℱ ( {w}^{*} ) )}{λ T} + \frac{1}{T} {\sum }_{t = 1}^{T} {\sum }_{i = 1}^{I} \frac{{J}_{i} {s}_{i}^{t} {σ}^{2}}{{( {b}_{i}^{t} )}^{2} {λ}^{2} {D}^{2}} + \frac{1}{T} {\sum }_{t = 1}^{T - 1} {\sum }_{i = 1}^{I} ( 1 - {s}_{i}^{t} δ ) {G}_{i}^{2}$$

$$Based on {u}_{k}^{t} = λ {g}_{k}^{t} and {c}_{k , i}^{t} = λ {g}_{k , i}^{t} - 𝒸 ( λ {g}_{k , i}^{t} ) ,$$

the loss function can be derived as shown in Equation 46.

$${w}^{t + 1} = {w}^{t} - λ {g}^{t} + \frac{1}{D} {\sum }_{k = 1}^{K} {D}_{k} {c}_{k}^{t} - {a}^{t} \qquad [ Equation 46 ]$$

According to Assumption 3, in each communication round t, the global loss function [symbol] (⋅) with w^{t+1} can be bounded as shown in Equation 47.

$$ℱ ( {w}^{t + 1} ) \leq ℱ ( {w}^{t} ) + {( {w}^{t + 1} - {w}^{t} )}^{T} ∇ ℱ ( {w}^{t} ) + \frac{L}{2} {‖ {w}^{t + 1} - {w}^{t} ‖}_{2}^{2} . \qquad [ Equation 47 ]$$

Furthermore, according to Assumption 4, Equation 47 can be bounded as shown in Equation 48.

$$[ Equation 48 ]$$

$$\begin{matrix}𝔼 [ ℱ ( {w}^{t + 1} ) ] \leq ℱ ( {w}^{t} ) + {𝔼 [ ( {w}^{t + 1} - {w}^{t} ) ]}^{T} ∇ ℱ ( {w}^{t} ) + \frac{L}{2} 𝔼 {‖ {w}^{t + 1} - {w}^{t} ‖}_{2}^{2} \\ = ℱ ( {w}^{t} ) + ( 1 - λ L ) {𝔼 [ ( \frac{1}{D} {\sum }_{k = 1}^{K} {D}_{k} {c}_{k}^{t} - {a}^{t} ) ]}^{T} ∇ ℱ ( {w}^{t} ) \\ - \frac{λ}{2} ( 2 - λ L ) {‖ ∇ ℱ ( {w}^{t} ) ‖}_{2}^{2} + \frac{L}{2} 𝔼 {‖ \frac{1}{D} {\sum }_{k = 1}^{K} {D}_{k} {c}_{k}^{t} - {a}^{t} ‖}_{2}^{2} \\ = ℱ ( {w}^{t} ) - \frac{λ}{2} {‖ ∇ ℱ ( {w}^{t} ) ‖}_{2}^{2} + \frac{1}{2 λ} 𝔼 {‖ \frac{1}{D} {\sum }_{k = 1}^{K} {D}_{k} {c}_{k}^{t} ‖}_{2}^{2} + \frac{1}{2 λ} 𝔼 {‖ {a}^{t} ‖}_{2}^{2} .\end{matrix}$$

For a simpler expression without compromising generality, L can be set to 1/λ. Then according to Assumption 1,

$${‖ {c}_{k , i}^{t} ‖}_{2}^{2} \leq ( 1 - {s}_{i}^{t} δ ) {λ}^{2} {G}_{i}^{2}$$

can be defined. Therefore, Equation 48 can be rearranged as shown in Equation 49 based on Lemma 2 and Jensen's inequality.

$$[ Equation 49 ]$$

$$𝔼 [ ℱ ( {w}^{t + 1} ) ] \leq ℱ ( {w}^{t} ) - \frac{λ}{2} {‖ ∇ ℱ ( {w}^{t} ) ‖}_{2}^{2} + {\sum }_{i = 1}^{I} \frac{{J}_{i} {s}_{i}^{t} {σ}^{2}}{2 {( {b}_{i}^{t} )}^{2} λ {D}^{2}} + \frac{1}{2 λ D} {\sum }_{k = 1}^{K} {D}_{k} 𝔼 {‖ {c}_{k}^{t} ‖}_{2}^{2} \leq ℱ ( {w}^{t} ) - \frac{λ}{2} {‖ ∇ ℱ ( {w}^{t} ) ‖}_{2}^{2} + {\sum }_{i = 1}^{I} \frac{{J}_{i} {s}_{i}^{t} {σ}^{2}}{2 {( {b}_{i}^{t} )}^{2} λ {D}^{2}} + \frac{1}{2 λ D} {\sum }_{k = 1}^{K} {D}_{k} {\sum }_{i = 1}^{I} 𝔼 {‖ {c}_{k , i}^{t} ‖}_{2}^{2} \leq ℱ ( {w}^{t} ) - \frac{λ}{2} {‖ ∇ ℱ ( {w}^{t} ) ‖}_{2}^{2} + {\sum }_{i = 1}^{I} \frac{{J}_{i} {s}_{i}^{t} {σ}^{2}}{2 {( {b}_{i}^{t} )}^{2} λ {D}^{2}} + \frac{λ}{2} {\sum }_{i = 1}^{I} ( 1 - {s}_{i}^{t} δ ) {G}_{i}^{2} .$$

According to Assumption 3, by rearranging the terms and taking the average on both sides with respect to t, it can be expressed as shown in Equation 50.

$$[ Equation 50 ]$$

$$\text{} \frac{1}{T} {\sum }_{t = 1}^{T} {‖ ∇ ℱ ( {w}^{t} ) ‖}_{2}^{2} \leq \frac{2}{λ} ( ℱ ( {w}^{1} ) - ℱ ( {w}^{*} ) ) + \frac{1}{T} {\sum }_{t = 1}^{T} {\sum }_{i = 1}^{I} \frac{{J}_{i} {s}_{i}^{t} {σ}^{2}}{{( {b}_{i}^{t} )}^{2} {λ}^{2} {D}^{2}} + \frac{1}{T} {\sum }_{t = 1}^{T} {\sum }_{i = 1}^{I} ( 1 - {s}_{i}^{t} δ ) {G}_{i}^{2} .$$

According to observations from Theorem 1 and Theorem 2, the FL system can achieve an improved convergence performance by minimizing the total error upper bound.

The second term on the RHS of Equation 35 is a gradient-weighted upper bound constant, and the other terms decrease as the maximum communication round T increases. Notably, the third term and the last term represent a weighted aggregation error (WAE) and a weighted compression error (WCE), respectively.

Similarly, all terms on the right-hand side of Equation 45 decrease as maximum communication round T increases, and the second term and last term represent the WAE and the WCE, respectively. The WAE, which is the negative impact of noise, decreases as the amplitude scaling factor

$${b}_{\text{?}}^{\text{?}}$$

$$\text{?} \text{indicates text missing or illegible when filed}$$

increases and is eliminated when the sparse masking indicator

$${s}_{\text{?}}^{\text{?}}$$

$$\text{?} \text{indicates text missing or illegible when filed}$$

is 0. However, WAE decrease when the sparse masking indicator

$${s}_{\text{?}}^{\text{?}}$$

$$\text{?} \text{indicates text missing or illegible when filed}$$

is 1. That is, when

$${s}_{i}^{t} = 0 ,$$

the WAE decreases, and the WCE increases. In contrast, when

$${s}_{i}^{t} = 1$$

vice versa. Therefore,

$${s}_{\text{?}}^{t} and {b}_{\text{?}}^{t}$$

$$\text{?} \text{indicates text missing or illegible when filed}$$

determine the WAE and WCE, which can affect the learning performance and communication costs. Using this theoretical convergence analysis, a joint optimization can be designed to minimize the upper-bound of the convergence rate and the total error by determining the compression rate through

$${s}_{\text{?}}^{t}$$

$$\text{?} \text{indicates text missing or illegible when filed}$$

and controlling the transmit power through

$${b}_{\text{?}}^{t} .$$

$$\text{?} \text{indicates text missing or illegible when filed}$$

This will be explained further.

In the case of the sparse one-bit analog aggregation with error-feedback mechanism (SOBBA-EFO), server can determine all amplitude scaling factors

$${b}^{\text{?}} = {\{ {b}_{i}^{\text{?}} \}}_{i = 1}^{I}$$

$$\text{?} \text{indicates text missing or illegible when filed}$$

and all sparse masking indicators

$${s}^{t} = {\{ {s}_{i}^{t} \}}_{i = 1}^{I}$$

at each communication round t in order to minimize Equation 35.

The total error l^{t} can be derived as shown in Equation 51 by eliminating the common factors after dropping the irrelevant terms in Equation 35,

$${e}^{t} = {\sum }_{i = 1}^{I} \frac{{J}_{i} {s}_{i}^{t} {σ}^{2}}{{( {b}_{i}^{t} )}^{2} {λ}^{2} {D}^{2}} + {\sum }_{i = 1}^{I} \frac{( 1 - {s}_{i}^{t} δ ) {G}_{i}^{2}}{δ} \times ( {( t - {S}_{i} )}^{2} + \frac{( 2 - δ ) {M}_{i}^{2}}{δ} ) \qquad [ Equation 51 ]$$

In order for

$${u}_{\text{?}}^{\text{?}}$$

$$\text{?} \text{indicates text missing or illegible when filed}$$

in Equation 17 not to be significantly distorted by noise, the post-processing noise must decreases as shown in Equation 52 according to the variance expression based on the expected value.

$$𝔼 {\vert \frac{{z}_{i , j}^{t}}{{b}_{i}^{t} D} \vert}^{2} = \frac{{σ}^{2}}{{( {b}_{i}^{t} )}^{2} {D}^{2}} \leq {ϵσ}^{2} \qquad [ Equation 52 ]$$

Here, ϵ∈[0,1] represents a rate of decrease, and based on the observation when ϵ approaches 0, Equation 51 shows that it is smaller when

$${s}_{i}^{t} = 1 than$$

$${s}_{i}^{t} = 0.$$

Therefore, in all rounds, all layers are transmitted and all are negatively affected by noise.

At each round T, the communication cost of the FL system can be defined as shown in Equation 53.

$$Communication cost = {\sum }_{i = 1}^{I} {J}_{i} {s}_{i}^{t} \qquad [ Equation 53 ]$$

The communication cost is in the same form as the WAE with some factors removed. In other words, the communication cost and the WAE increase or decrease at nearly the same rate according to s^{t}′. Therefore, if all devices transmit all layers, it is not possible to minimize the negative impact of the noise and the communication cost. Therefore, in order to improve the convergence rate and communication efficiently, γ^{1,t} can be defined as shown in Equation 54.

$${r}^{1 , t} = ( 1 - θ ) {{\sum }_{i = 1}}^{I} \frac{{J}_{i} {s}_{i}^{t} {σ}^{2}}{{( {b}_{i}^{t} )}^{2} {λ}^{2} {D}^{2}} + θ {{\sum }_{i = 1}}^{I} \frac{( 1 - {s}_{i}^{t} δ ) {G}_{i}^{2}}{δ} \times ( {( t − {S}_{i} )}^{2} + \frac{( 2 - δ ) {M}_{i}^{2}}{δ} ) , \qquad [ Equation 54 ]$$

Here, θ∈[0,1] represents a weight factor.

In order to determine b^{t} and s^{t}, server must consider the transmit power constraint (Equation 15) on each device. Among the various elements of Equation 15, the number of samples per device, Dₖ, is assumed to be known to the server when the FL system initialize the training process and remains unchanged until the end of the iteration.

Additionally, the channel coefficient

$${h}_{k}^{t}$$

is assumed to be known to the server and easily estimable through the uplink pilot signals transmitted by the devices, according to the 3GPP standards. However, the amplitude scaling factor

$${υ}_{k , i}^{t} .$$

is unknown, so the server needs to estimated it.

Therefore, based on Assumption 1, Lemma 1 and

$$δ = {{J}_{i} ( {υ}_{k , i}^{t} )}^{2} / {‖ {u}_{k , i}^{t} ‖}_{2}^{2} \text{?} , {υ}_{k , i}^{t}$$

$$\text{?} \text{indicates text missing or illegible when filed}$$

can be bounded as shown in Equation 55.

$$[ Equation 55 ]$$

$$\begin{matrix} & {( {υ}_{k , i}^{k} )}^{2} = \frac{δ}{{J}_{i}} {‖ {u}_{k , i}^{t} ‖}_{2}^{2} \leq \frac{( 2 - δ ) {λ}^{2} {G}_{i}^{2}}{{J}_{i}} ( {( t − {S}_{i} )}^{2} + \frac{( 2 − δ ) {M}_{i}^{2}}{δ} )\end{matrix} = {( {V}_{i}^{1 , t} )}^{2} ,$$

Here,

$${( {V}_{i}^{1 , t} )}^{2}$$

represents an achievable upper bound of

$${( {υ}_{k , i}^{t} )}^{2} .$$

Using this, the transmit power constraint (Equation 15) can be rearranged as shown in Equation 56.

$${\vert \frac{{b}_{i}^{t} {D}_{k} {s}_{i}^{t} υ \text{?}}{{h}_{k}^{t}} \vert}^{2} \leq \frac{{{s}_{i}^{t} ( {V}_{i}^{1 , t} )}^{2} {( {b}_{i}^{t} )}^{2}}{{( {h}_{k}^{t} )}^{2}} = {s}_{i}^{t} {{o}_{k , i}^{1 , t} ( {b}_{i}^{t} )}^{2} \qquad [ Equation 56 ]$$

$${s}_{i}^{t} {o}_{k , i}^{1 , t} {( {b}_{i}^{t} )}^{2} \leq P \qquad [ Equation 57 ]$$

$$\text{?} \text{indicates text missing or illegible when filed}$$

Here,

$${o}_{k , i}^{1 , t} .$$

is defined as the remaining elements excluding

$${b}_{i}^{t} .$$

$$and$$

$${s}_{i}^{t} .$$

To satisfy a new transmit power constraint (Equation 57), it is assumed that the maximum non-transmit period Mᵢ is upper bounded layer-wise by a positive constant based on Equation 52 and t−Sᵢ=M_{i′}. This can be expressed as Equation 58.

$$\begin{matrix}𝔼 [ {M}_{i}^{2} ] & \leq 𝔼 [ \frac{δ {PJ}_{i} {( {h}_{k}^{t} )}^{2}}{2 ( 2 − δ ) {( {b}_{i}^{t} )}^{2} {λ}^{2} {G}_{i}^{2} ℳ ( {D}_{k}^{2} )} ]\end{matrix} \leq \frac{ϵ δ {PJ}_{i} {D}^{2}}{( 2 − δ ) {λ}^{2} {G}_{i}^{2} {D}_{k}^{2}} ,$$

Here, [symbol] (⋅) represents a max function. Then Mᵢ can be bounded as shown in Equation 59.

$${M}_{i} \leq ℳ ( 1 , ⌊ \sqrt{\frac{ϵ δ {PJ}_{i} {D}^{2}}{( 2 − δ ) {λ}^{2} {G}_{i}^{2} ℳ ( {D}_{k}^{2} )}} ⌋ ) \qquad [ Equation 59 ]$$

Based on Equation 59, Equation 57 can be satisfied.

Based on Equation 54 and Equation 57, the joint optimization problem for the sparse one-bit analog aggregation with error-feedback mechanism (SOBBA-EFO) can be formulated as shown in Equation 60.

$$[ Equation 60 ]$$

$$\begin{matrix}\begin{matrix}P 2 : & min \text{?}\end{matrix} & r \text{?}\end{matrix} , \qquad ( 60 a )$$

$$\begin{matrix}s . t . & {s}_{i}^{t}\end{matrix} o \text{?} ( {b}_{i}^{t} ) \leq P , ∀ k , i , \qquad ( 60 b )$$

$$t - {S}_{i} \leq {M}_{i} , ∀ i . \qquad ( 60 c )$$

$${{\sum }_{i = 1}}^{I} {s}_{i}^{t} \geq 1 , \qquad ( 60 d )$$

$${s}_{i}^{t} ∈ \{ 0 , 1 \} , ∀ i . \qquad ( 60 e )$$

$${b}_{i}^{t} > 0 , ∀ i , \qquad ( 60 f )$$

$$\text{?} \text{indicates text missing or illegible when filed}$$

In equation 60, 60d represents a layer-wise sparsification constraint that one or more layers to be transmitted at each communication round t for the convergence performance. By removing the irrelevant terms from Equation 45 and using the wight factor θ, γ^{2,t} can be defined as shown in Equation 61.

$${r}^{2 , t} = ( 1 − θ ) {\sum }_{i = 1}^{I} \frac{{J}_{i} {s}_{i}^{t} {σ}^{2}}{{( {b}_{i}^{t} )}^{2} {λ}^{2} {D}^{2}} + θ {\sum }_{i = 1}^{I} ( 1 − {s}_{i}^{t} δ ) {G}_{i}^{2} \text{?} \qquad [ Equation 61 ]$$

$$\text{?} \text{indicates text missing or illegible when filed}$$

Thus, based on

$${u}_{k}^{t} = λ {g}_{k}^{t}$$

and Cauchy-Schwarz inequality,

$${v}_{k , i}^{t} .$$

can be bounded as shown in Equation 62.

$$\begin{matrix}\text{?} = \frac{1}{{J}_{i}^{2}} {‖ λ \text{?} ‖}_{1}^{2} \leq \frac{1}{{J}_{i}} {‖ λ \text{?} ‖}_{2}^{2} \\ \leq \frac{{λ}^{2} {G}_{i}^{2}}{{J}_{i}} = {( \text{?} )}^{2} ,\end{matrix} \qquad [ Equation 62 ]$$

$$\text{?} \text{indicates text missing or illegible when filed}$$

Where,

$${( {V}_{i}^{2 , t} )}^{2}$$

represents an achievable upper bound of

$${( {v}_{k , i}^{t} )}^{2} .$$

Therefore, the joint optimization problem for sparse one-bit analog aggregation without error-feedback mechanism (SOBAA-EFX) can be formulated as shown in Equation 63.

$$\begin{matrix}[ Equation 63 ] & \\ P 3 : m \text{?} n \text{?} , & ( 63 a )\end{matrix}$$

$$s . t . \text{?} \leq P , ∀ k \text{?} , \qquad ( 63 b )$$

$$\text{?} \geq 1 , \qquad ( 63 c )$$

$$\text{?} ∈ \{ 0 , 1 \} \text{?} ∀ i , \qquad ( 63 d )$$

$$\text{?} > \text{?} ∀ i , \qquad ( 63 e )$$

$$\text{?} \text{indicates text missing or illegible when filed}$$

Where,

$${o}_{k , i}^{2 , t} \text{?}$$

$$\text{?} \text{indicates text missing or illegible when filed}$$

is represented using

$${( {V}_{i}^{2 , t} )}^{2} \text{?}$$

$$\text{?} \text{indicates text missing or illegible when filed}$$

instead of

$${( {V}_{i}^{1 , t} )}^{2} \text{?}$$

$$\text{?} \text{indicates text missing or illegible when filed}$$

Because of combination of the real-valued variable amplitude scaling factor

$$\text{?}$$

$$\text{?} \text{indicates text missing or illegible when filed}$$

and the binary-valued variable sparse masking indicator

$${s}_{i}^{t} ,$$

P2 is a mixed integer programming and a non-convex problem. However,

$${b}_{i}^{t} \text{?} and {s}_{i}^{t}$$

$$\text{?} \text{indicates text missing or illegible when filed}$$

are not correlated with each other within and between the layers. This implies that regardless of the given

$${s}_{i}^{t} ,$$

P2 can be transformed into a convex problem for determines the optimal solution for

$${b}_{i}^{t} \text{?} .$$

$$\text{?} \text{indicates text missing or illegible when filed}$$

Therefore, P2 can be decomposed into two subproblems for finding

$${b}_{i}^{t} \text{?} and {s}_{i}^{t} ,$$

$$\text{?} \text{indicates text missing or illegible when filed}$$

respectively.

First, to determine

$${b}_{i}^{t} \text{?} ,$$

$$\text{?} \text{indicates text missing or illegible when filed}$$

an auxiliary function is defined, and the part of P2 can be reformulated as shown in Equation 64.

$$[ Equation 64 ]$$

$$P4 : {min}_{\text{?} \text{?}} {ℛ}_{1} ( b \text{?} ) = ( 1 - θ ) \sum \text{?} \text{?} \frac{J \text{?} {σ}^{2}}{{( b \text{?} \text{?} )}^{2} {λ}^{2} {D}^{2}} , \qquad ( 64 a )$$

$$s . t . {{o}_{k , i}^{1 , t} ( {b}_{i}^{t} )}^{2} \leq P , ∀ k , i , ( 39 f ) . \qquad ( 64 b )$$

$$\text{?} \text{indicates text missing or illegible when filed}$$

All

$${b}_{i}^{t} .$$

are not correlated with each other. Thus, P4 can be decomposed into smaller I parallel subproblems. This can be expressed as shown in Equation 65.

$${min}_{\text{?} \text{?}} {ℛ}_{1 , i} ( {b}_{i}^{t} ) = ( 1 - θ ) \frac{{J}_{i} {σ}^{2}}{{( {b}_{i}^{t} )}^{2} {λ}^{2} {D}^{2}} \qquad [ Equation 65 ]$$

$$\text{?} \text{indicates text missing or illegible when filed}$$

To solving P4, Lagrange dual method is utilized by introducing a multiplier

$${q}^{t} = {\{ {q}_{i}^{t} \}}_{i = 1}^{I}$$

for the constraint 64b, and the partial Lagrangian can be derived as shown in Equation 66.

$$ℒ ( b \text{?} , q \text{?} ) = {ℛ}_{1} ( b \text{?} ) + {\sum }_{k = 1}^{K} {\sum }_{i = 1}^{I} {q}_{i}^{t} ( {{o}_{k , i}^{1 , t} ( {b}_{i}^{t} )}^{2} - P ) \qquad [ Equation 66 ]$$

$$\text{?} \text{indicates text missing or illegible when filed}$$

The dual problem can be derived as shown in Equation 67.

$$P5 : {max}_{q \text{?}} 𝒟 ( {q}^{t} ) , \qquad [ Equation 67 ]$$

$$s . t . {q}_{i}^{t} \geq 0 , ∀ i ,$$

$$\text{?} \text{indicates text missing or illegible when filed}$$

Where, the dual function [symbol] (⋅) is defined as shown in Equation 68.

$$𝒟 ( {q}^{t} ) = {min}_{b \text{?}} ℒ ( {b}^{t} ) , \qquad [ Equation 68 ]$$

$$s . t . ( 39 f ) .$$

$$\text{?} \text{indicates text missing or illegible when filed}$$

According to the strong duality between the primal problem and the dual problem, the primal problem P4 can be solved by solving the dual problem P5. Thus, P5 can be decomposed into I smaller parallel convex subproblems, as shown in Equation 69.

$${min}_{b \text{?} \text{?}} {ℒ}_{i} ( {b}_{i}^{t} ) = {ℛ}_{1 , i} ( {b}_{i}^{t} ) + {\sum }_{k = 1}^{K} {q}_{i}^{t} ( {{o}_{k , i}^{1 , t} ( {b}_{i}^{t} )}^{2} - P ) \qquad [ Equation 69 ]$$

$$\text{?} \text{indicates text missing or illegible when filed}$$

Equation 69 can be solved using efficient convex optimization tools.

Additionally, another auxiliary function is defined to determine

$${S}_{i}^{t} \text{?} ,$$

$$\text{?} \text{indicates text missing or illegible when filed}$$

and the part of P2 can be reformulated as shown in Equation 70.

$$P6 : {min}_{\text{?}} {ℛ}_{2}^{1} ( {s}^{t} ) = ( 1 - θ ) {\sum }_{i = 1}^{} \text{?} \frac{{J}_{i} \text{?} \text{?} {σ}^{2}}{{( b \text{?} \text{?} )}^{2} {λ}^{2} {D}^{2}} + θ {\sum }_{i = 1}^{} \text{?} \frac{( 1 - \text{?} \text{?} \text{?} ) G \text{?}}{δ} \times ( {( t - {S}_{i} )}^{2} + \frac{( 2 - δ ) M \text{?}}{δ} ) , \qquad [ Equation 70 ]$$

$$s . t . ( 39 c ) , ( 39 d ) , ( 39 e ) ,$$

$$\text{?} \text{indicates text missing or illegible when filed}$$

Where,

$${b}^{t {,}^{*}} = {\{ {b}_{i}^{t {,}^{*}} \}}_{i = 1}^{I}$$

represents all determined amplitude scaling factors by solving P5. P6 can be solved using the enumeration-based method that derives the best case among all possibilities. However, for the sparse one-bit analog aggregation with error-feedback mechanism (SOBAA-EFO) according to an embodiment of the present discourse, this method is computationally infeasible as it requires enumerating and comparing all 2^{t} possible cases. All

$${S}_{i}^{t} \text{?} \text{?}$$

$$\text{?} \text{indicates text missing or illegible when filed}$$

are not correlated with each other, P6 can be decomposed into I smaller parallel subproblems. This can be expressed as shown in Equation 71.

$${min}_{\text{?}} {ℛ}_{2 , i}^{1} ( {s}_{i}^{t} ) = ( 1 - θ ) {\sum }_{i = 1}^{} \text{?} \frac{{J}_{i} \text{?} \text{?} {σ}^{2}}{{( b \text{?} \text{?} )}^{2} {λ}^{2} {D}^{2}} + θ \frac{( 1 - \text{?} \text{?} \text{?} ) G \text{?}}{δ} \times ( {( t - {S}_{i} )}^{2} + \frac{( 2 - δ ) M \text{?}}{δ} ) , \qquad [ Equation 71 ]$$

$$\text{?} \text{indicates text missing or illegible when filed}$$

If t−Sᵢ=Mᵢ in Equation 60c, subproblem i can be solved as

$$\text{?} \text{?} = 1.$$

$$\text{?} \text{indicates text missing or illegible when filed}$$

Otherwise, each subproblem need to be solved by comparing values of

$$\text{?} \text{?} = 0 and \text{?} \text{?} = 1$$

$$\text{?} \text{indicates text missing or illegible when filed}$$

as shown in Equation 72 and Equation 73.

$${ℛ}_{2 , i}^{1} ( 0 ) = θ \frac{{G}_{i}^{2}}{δ} ( {( t - {S}_{i} )}^{2} + \frac{( 2 - δ ) {M}_{i}^{2}}{δ} ) \qquad [ Equation 72 ]$$

$$\text{?} ( 1 ) = ( 1 - θ ) \frac{\text{?}}{\text{?} {λ}^{2} {D}^{2}} + θ \frac{( 1 - δ ) {G}_{i}^{2}}{δ} \times ( {( t - {S}_{i} )}^{2} + \frac{( 2 - δ ) {M}_{i}^{2}}{δ} ) \text{?} \qquad [ Equation 73 ]$$

$$\text{?} \text{indicates text missing or illegible when filed}$$

Since constraint 60d may not be satisfied, to meet this constraint while minimizing Equation 70, Equation 73 must derive the smallest layer. However, due to the difference in the number of parameters between layers and difference in the magnitude of gradients, it is possible to derive only a specific layer in each round. Since the contribution of each layer to the learning model varies, deriving only the specific layer could degrade the convergence rate and learning performance. Therefore, the layer i* with the smallest growth rate of

$$\text{?} = 1$$

$$\text{?} \text{indicates text missing or illegible when filed}$$

compared to

$$\text{?} = 0$$

$$\text{?} \text{indicates text missing or illegible when filed}$$

a should be derived, as shown in Equation 74.

$${i}^{*} = arg \begin{matrix}min \\ i\end{matrix} \frac{{ℛ}_{2 , i}^{1} ( 1 )}{{ℛ}_{2 , i}^{1} ( 0 )} . \qquad [ Equation 74 ]$$

All the determined sparse masking indicators

$$\text{?} = \{ \text{?}$$

$$\text{?} \text{indicates text missing or illegible when filed}$$

can be obtained by setting

$$\text{?} = 1.$$

$$\text{?} \text{indicates text missing or illegible when filed}$$

The computational complexity of solving the smaller parallel subproblems is scaled by I, so the computational complexity for the solutions of P5 and P6 is o(I). Therefore, the computation complexity of the solution according to an embodiment of the present disclosure, which solves P5 and P6 sequentially, is o(I), which is scaled linearly with I. Therefore, the solution according to an embodiment of the present disclosure can determine the optimal value based on the computationally feasible complexity.

The pseudo-code for the decomposition-based feasible solution according to an embodiment of the present disclosure is as shown in FIG. 2. Here, o^{1,t} represents all

$$\text{?}$$

$$\text{?} \text{indicates text missing or illegible when filed}$$

for all k and i.

In each communication round t, the server (110) can derive b^{t,*} and s^{t,*}, and broadcast them to all devices. Given b^{t,*} and s^{t,*}, each device can derive

$$\text{?}$$

$$\text{?} \text{indicates text missing or illegible when filed}$$

according to Equation 10, and send it to the server according to Equation 16. To solve P3, the auxiliary function in Equation 64 can be used, other auxiliary functions can be defined as shown in Equation 75.

$${ℛ}_{2}^{2} ( {s}^{t} ) = ( 1 - θ ) \text{?} \frac{{J}_{i} {s}_{i}^{t} {σ}^{2}}{\text{?} {λ}^{2} {D}^{2}} + θ \text{?} ( 1 - \text{?} ) {G}_{i}^{2} , \qquad [ Equation 75 ]$$

$$\text{?} \text{indicates text missing or illegible when filed}$$

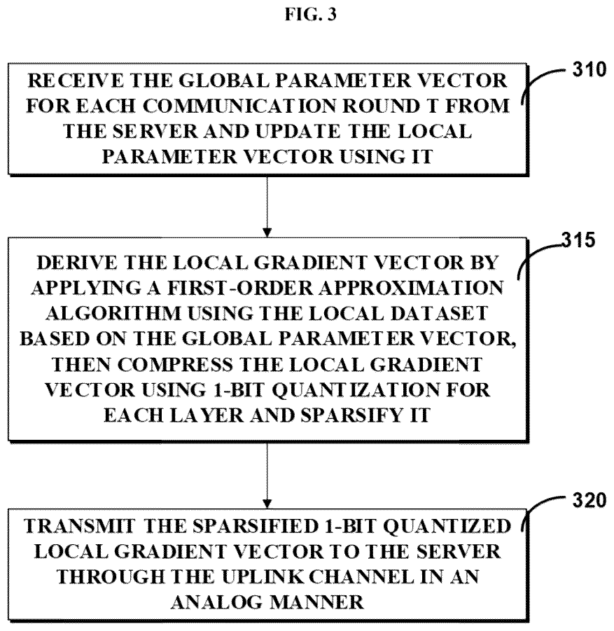

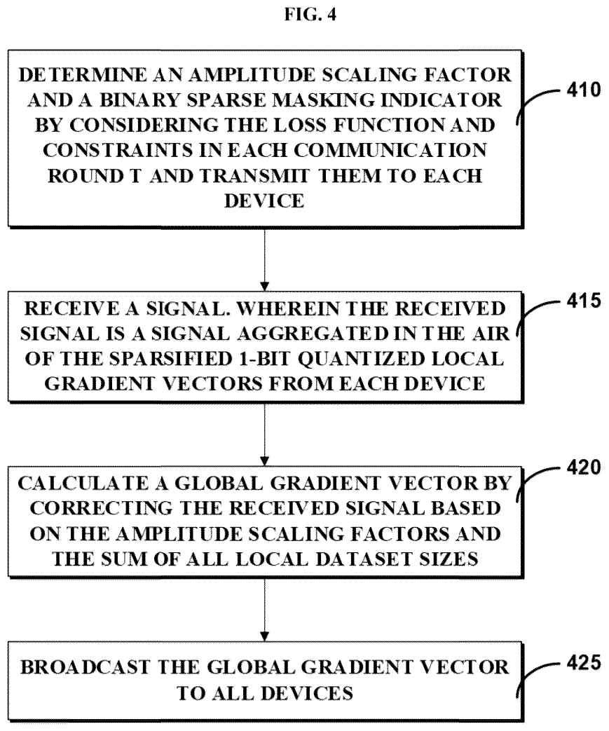

The remaining process is the same as the solving process for P2, thus it is omitted. For the convenience of understanding and explanation, the operations performed by each device and the server are summarized as follows, with reference to FIGS. 3 and 4.

FIG. 3 is a flowchart illustrating a sparse 1-bit quantization-based federated learning method performed on each device according to an embodiment of the present disclosure.

In step 310, the device can receive the global parameter vector for each communication round t from the server and update the local parameter vector using the global gradient vector.

In step 315, the device can derive the local gradient vector by applying a first-order approximation algorithm using the local dataset based on the global parameter vector, then compress the local gradient vector using 1-bit quantization for each layer and sparsify it. The device can calculate the layer-specific local gradient vector magnitude scaling factors, and derive a sparse 1-bit quantized local gradient vector using calculated magnitude scaling factors and layer-specific sparse masking indicator.

In step 320, the device can transmit the sparsified 1-bit quantized local gradient vector to the server through the uplink channel in an analog manner.

Sinch each step is explained in detail with reference to FIG. 1, redundant explanation will be omitted.

FIG. 4 is a flowchart illustrating a sparse 1-bit quantization-based over-the-air federated learning method performed on server according to an embodiment of the present disclosure.

In step 410, the server can determine an amplitude scaling factor and a binary sparse masking indicator by considering the loss function and constraints in each communication round t and transmit them to each device. This is same as described with reference to FIG. 1, so a redundant description will be omitted.

In step 415, the server can receive a signal. Wherein the received signal is a signal aggregated in the air of the sparsified 1-bit quantized local gradient vectors from each device.

In step 420, the server can calculate a global gradient vector by correcting the received signal based on the amplitude scaling factors and the sum of all local dataset sizes.

In step 425, the server can broadcast the global gradient vector to all devices. Since each step is the same as described with reference to FIG. 1, redundant description will be omitted.

In one embodiment of the present discourse, a FLOA system with one server and K=25 devices is considered, with the maximum transmission power P=10 mW and the noise power σ²=10⁻⁴ mW, respectively.

To evaluate the learning performance and communication efficiency of sparse one-bit analog aggregation (hereinafter referred to as SOBAA) according to an embodiment of the present disclosure, it was compared with OBDA (One-bit Broadband Digital Aggregation) and EFOBDA (Error-Feedback OBDA).

In terms of gradient compression scheme, OBDA is a method that adopts unscaled 1-bit quantization, but does not adopt sparsification and error feedback mechanisms. FEOBDA is a more advanced method that adopts unscaled 1-bit quantization and error feedback mechanism, but does not adopt sparsification. SOBBA-EFO/EFX according to an embodiment of the present disclosure is a method that adapts layer-wise scaled one-bit quantization and layer-wise sparsification with/without the error-feedback mechanism. As an application of this experimental evaluation, image classification, a fundamental task in vision recognition, is considered using the well-known MNIST and CIFAR-10 datasets.

The MNIST dataset consists of 10 classes with black and-white handwritten digits ranging from 0 to 9 that are one color with 28×28 pixels, where D=60000 labeled training samples and 10000 test samples are available. The CIFAR-10 dataset consists of 10 mutually exclusive classes with colorful objects or animals that are RGB color with 32×32 pixels, where D=50000 labeled training samples and 10000 test samples are available.

In the numerical experiments, two cases were considered to partition the dataset over the 25 devices.

1) an I.I.D. case for both MNIST and CIFAR-10 datasets: The samples were shuffled and divided into 25 devices, each receiving Dₖ=D/25 samples.

2) a non-I.I.D. case for only MNIST dataset: The samples were sorted by digit label, divided into 200 shards with 300 samples each and then assigned to the 25 devices, with each device receiving 8 shards.

In particular, for the I.I.D MNIST dataset, a MLP based classifier is implemented with I=3 and J=199,210. The classifier consists of two hidden layers with 200 units each using the rectified linear units (ReLU) activation function.

For the non-I.I.D. MNIST dataset, a CNN-based classifier is implemented with I=4 and J=582,026, which is denoted as 4NN.

The CNN-based classifier (4NN) consists of two 5×5 convolutional layers with ReLU activation, a fully connected layer with 512 units and ReLU activation, and a final softmax output layer. Where The first convolutional layer consists of 32 channels and the second convolutional layer consists of 64 channels, each followed by 2×2 max-pooling.

For the I.I.D. CIFAR-10 dataset, a CNN-based classifier is implemented with I=5 and J=940,362, which is denoted as 5NN.

The CNN-based classifier (5NN) consists of two 5×5 convolutional layers, two fully connected layer, a linear transformation layer to produce logit. All environment were implemented using the Matlab optimization toolbox and Python programming language including Pytorch library on an Intel® Core i9-13900K machine with NVIDIA Geforce RTX 4080 and 32 GB memory, and all methods (SOBAA, OBDA, EFOBDA) were evaluated in the same environment.

By observing the parameters where all combinations of classifier and method converge in test accuracy, the learning rate λ is set to 0.1, and the maximum communication round T of the MNIST and CIFAR-10 datasets are set to 200 and 500, respectively.

Preliminary experiments were conducted to set the parameters of each classifier.

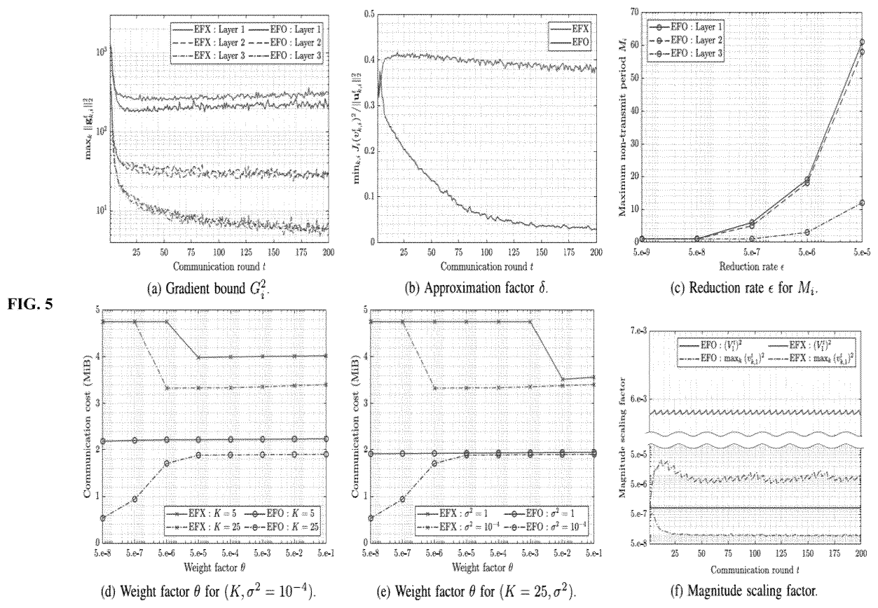

For example, FIG. 5 shows preliminary experiment result on the MLP classifier with I.I.D. MNIST dataset. Assuming an error-free channel

$$( \text{?} = 1 and \text{?} = 0 ) ,$$

$$\text{?} \text{indicates text missing or illegible when filed}$$

both EFO and EFX do not perform layer-wise sparsification at all communication rounds. Therefore,

$$\text{?}$$

$$\text{?} \text{indicates text missing or illegible when filed}$$

is set by measuring

$$m \text{?} x ‖ \text{?}$$

$$\text{?} \text{indicates text missing or illegible when filed}$$

in Equation 25 using (a) of FIG. 5.

In addition, δ is set by measuring

$$m \text{?} n \text{?} / {‖ \text{?} ‖}_{2}^{2}$$

$$\text{?} \text{indicates text missing or illegible when filed}$$

in Equation 20 using (b) of FIG. 5.

Moreover, based on Equation 59 and (c) of FIG. 5, ϵ was set so that all Mᵢ become less than or equal to 10, ensuring that each layer is transmitted at least once within 10 rounds. And then, under a fading channel, a weight factor θ was set for each device and each network condition.

(d) of FIG. 5 and (e) of FIG. 5 represent the required communication costs based on Equation 53 to achieve a 0.95 target test accuracy. When the target test accuracy is not achieved, the required communication cost is calculated as J×T. Regardless of θ, EFO is always lower than EFX due to the error-feedback mechanism. As θ decreases, the first term on the right-hand side of Equation 54 and Equation 61 increases for both EFO and EFX, resulting in less frequent layer transmissions and reduced communication costs. However, EFX fails to achieve the 0.95 target test accuracy when is significantly lower than a certain threshold, resulting in dramatically increased communication costs.

In FLOA, because all devices transmit simultaneously over the same time-frequency resources, the communication cost does not increase linearly with the number of devices, and it is the same as the communication cost of a single device. On the other hand, as the number of devices increases, the learning performance converges faster. That is, the required number of communication rounds to the convergence decreases, and it brings reduced communication costs as shown in (d) of FIG. 5.

Moreover, the thresholds of θ is reduced because the positive effect due to the increased number of training samples mitigates the negative effect from the infrequent transmission of layers. Similarly, (e) of FIG. 5 shows that as a noise power decreases, the learning performance converges faster and the required communication cost is decreased. Thus, for each combination (K, σ²), an appropriate θ that requires the least communication cost was selected to achieve the target test accuracy of 0.95. To set parameters on the other classifiers and datasets, similar preliminary experiments were performed, and then the parameters were determined.

In (f) of FIG. 5,

$$m \text{?} x \text{?} and \text{?}$$

$$\text{?} \text{indicates text missing or illegible when filed}$$

were measured based on Equation 8, Equation 55 and Equation 62.

The transmitted magnitude scaling factor is always lower than the estimated for both EFO and EFX in all communication rounds, it showed that the estimation operation is well performed.

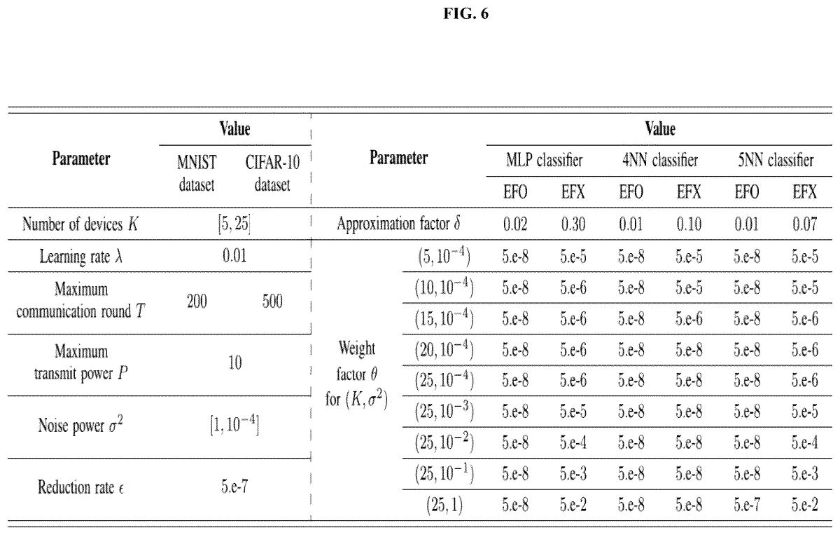

FIG. 6 is a diagram representing the experiment parameter settings. the SOBAA-EFO/EFX was evaluated for the MLP with the I.I.D. MNIST, the 4NN with the non-I.I.D. MNIST, and the 5NN with the I.I.D. CIFAR-10, demonstrating its effectiveness.

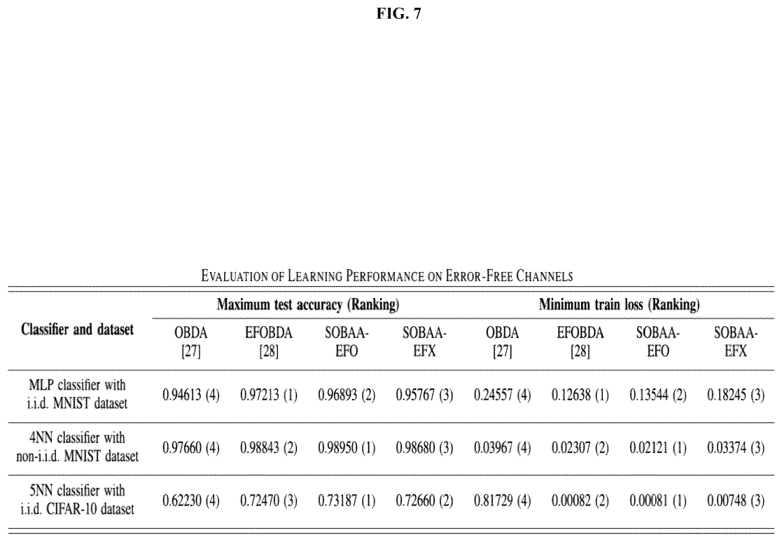

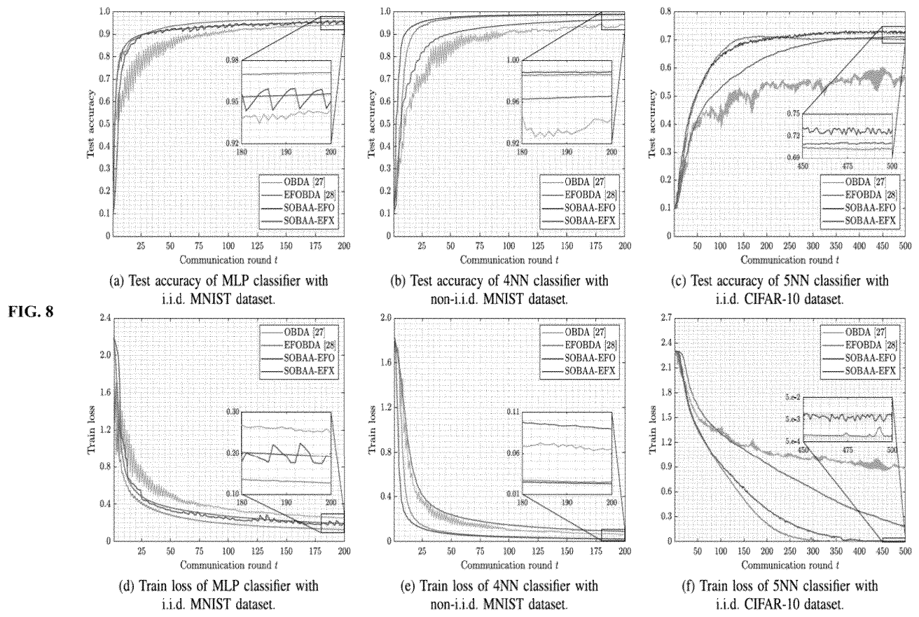

FIG. 7 is a diagram showing the maximum test accuracy, minimum training loss, and ranking in error-free channels. FIG. 8 shows the test accuracy and training loss according to communication rounds on fading channels.

For the MLP with the I.I.D. MNIST, in the error-free channels, SOBAA-EFO achieves better performance than SOBAA-EFX and OBDA. Here, SOBAA-EFO achieves slightly lower performance than EFOBDA, as aggregating only the sign rather than the sign and the magnitude can lead to better learning performance depending on the dataset and classifier. However, the test accuracy and train loss gaps between SOBAA-EFO and EFOBDA were significantly small, with values of 0.003 and 0.009, respectively. As shown (a) of FIG. 8 and (d) of FIG. 8, SOBAA-EFO in the fading channels achieves the same ranking as in the error-free channel.

For the 4NN with the non-I.I.D. MNIST, in error-free channels, SOBAA-EFO achieves the highest learning performance, followed in order by EFOBDA, SOBAA-EFX, and OBDA. As shown (b) of FIG. 8 and (e) of FIG. 8, SOBAA-EFO in the fading channels achieves the same ranking as in the error-free channel, but SOBAA-EFX has a little bit higher train loss than OBDA due to layer-wise sparsification.

For the 5NN with the I.I.D. CIFAR-10, in error-free channels, SOBAA-EFO achieves the highest learning performance, followed in order by SOBAA-EFX, EFOBDA, and OBDA with test accuracy, but followed in order by EFOBDA, SOBAA-EFX, and OBDA with train loss. As shown (c) of FIG. 8 and (f) of FIG. 8, SOBAA-EFO in fading channels achieves the same ranking with test accuracy, but it has a slightly higher train loss than EFOBDA due to layer-wise sparsification. Therefore, the SOBAA shows a better learning performance as the classifier and dataset became more complex. Notably, for the 5NN with the I.I.D. CIFAR-10 dataset, SOBAA-EFX achieves better test accuracy than EFOBDA for both the error-free and fading channels. In each communication round t, the compression ratio is defined as shown in Equation 76.

$$\begin{matrix}[ Equation 76 ] & \\ Compression ratio = \frac{1}{32 J} \text{?} & ( 76 )\end{matrix}$$

$$\text{?} \text{indicates text missing or illegible when filed}$$

Where 32 represents the number of bits by FloatTensor of the Pytorch library.

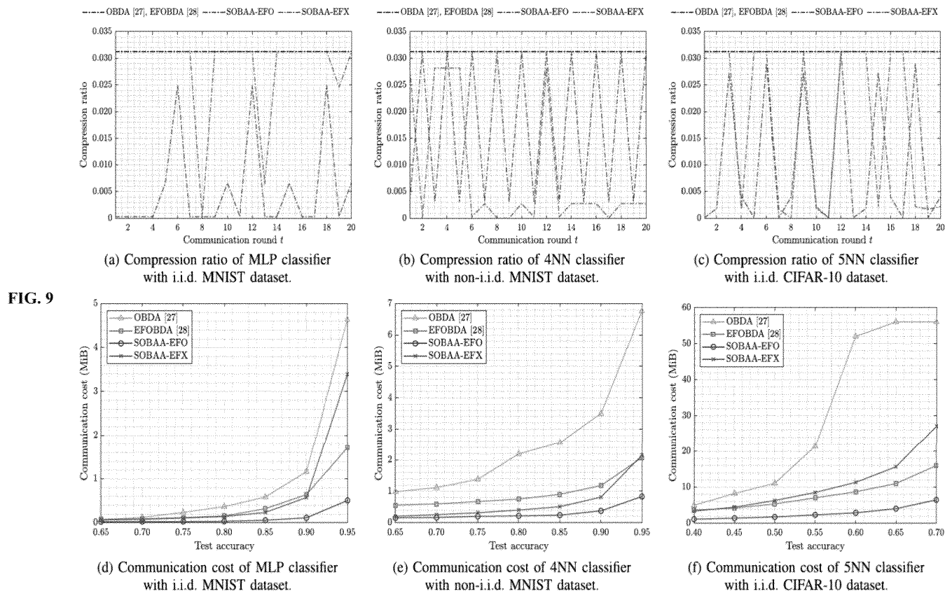

Based on Equation 76, (a) of FIG. 9, (b) of FIG. 9 and (c) of FIG. 9 show that SOBBA optimizes the gradient compression ratio according to the communication rounds, unlike the conventional method. In other world, unlike OBDA and EFOBDA, which show a fixed compression ratio of 1/32 across all classifiers and datasets, SOBAA shows different compression ratios depending on the communication rounds.

Then, the SOBAA was compared with the existing methods in terms of the trade-off between the target test accuracy and the communication cost required to achieve it. When the target accuracy is not achieved, the communication cost is calculated as J×T. As shown in (d) of FIG. 9, (e) of FIG. 9 and (f) of FIG. 9, the communication cost of OBDA increases dramatically as the test accuracy increases, exhibiting the worst trade-off. Moreover, OBDA may fail to achieve a 0.95, 0.95, and 0.6 test accuracy on the MLP, 4NN, and 5NN, respectively.

EFOBDA shows faster convergence and lower communication cost than OBDA due to the error feedback mechanism and power control optimization, resulting in an improved trade-off. SOBAA-EFX achieves a better trade-off than EFOBDA except for the target test accuracy of 0.95 in MLP and 4NN, while SOBAA-EFO provides the best trade-off.

SOBAA-EFO achieved a 70.5% and 59.8% reduction in communication cost compared to EFOBDA for the target test accuracy of 0.95 in MLP and 4NN, respectively. Additionally, SOBAA-EFO achieved a 59.6% reduction in communication cost compared to EFOBDA for the target test accuracy of 0.7 in 5NN.

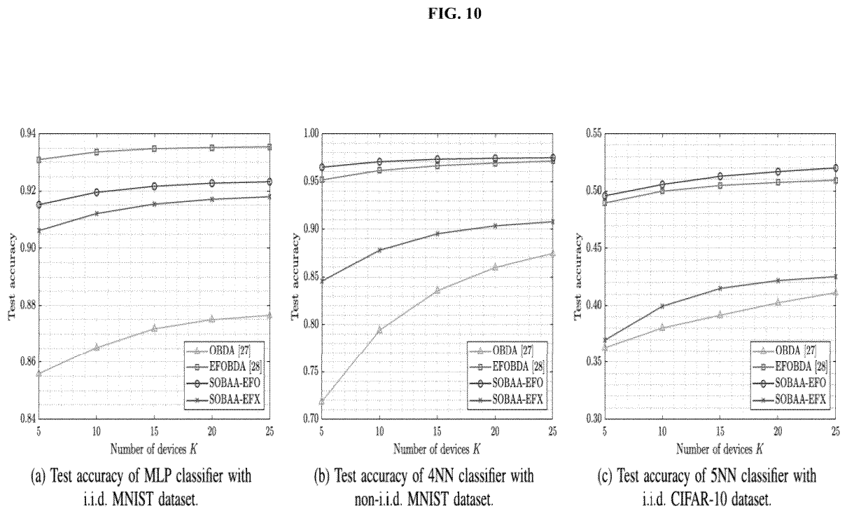

FIG. 10 compares SOBAA according to an embodiment of the present disclosure with other methods in terms of test accuracy, setting the maximum communication round T to 50 and varying the number of devices K. All methods show a decrease in test accuracy as K decreases, as fewer training samples are available when K is smaller. Notably, when K falls below a certain threshold, the test accuracy decreases exponentially.

Additionally, by comparing the test accuracy when K is 25 and 5, the robustness of the method according to an embodiment of the present disclosure was demonstrated. When the number of devices K decreases from 25 to 5, the test accuracy of the SOBAA-EFO decreases by only 0.006 in I.I.D. MNIST and MLP, indicating that SOBAA-EFO is more robust than OBDA and SOBAA-EFX, but slightly less robust than EFOBDA.

The test accuracy of the SOBAA-EFO decreases by only 0.01 in Non-I.I.D. MNIST and 4NN, and I.I.D. CIFAR-10 and 5NN, indicating that SOBAA-EFO is more robust than OBDA, EFOBDA, and SOBAA-EFX.

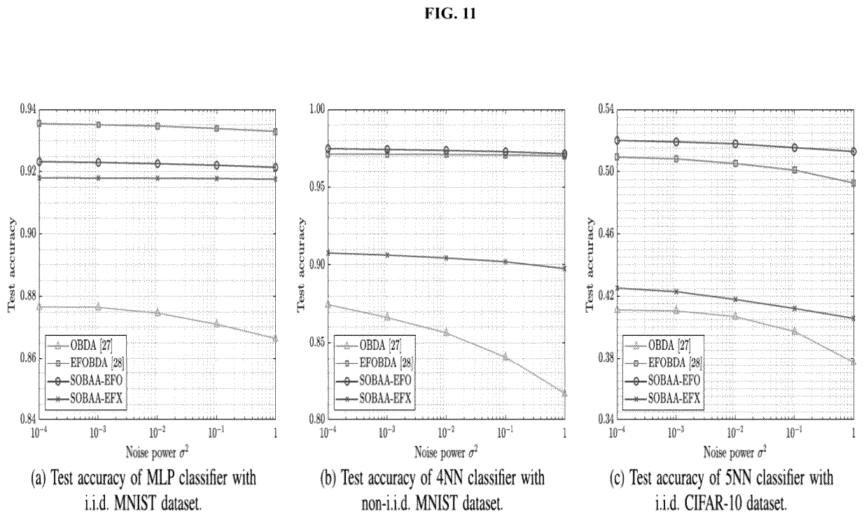

FIG. 11 compares the SOBAA with other methods in terms of test accuracy, setting the maximum communication round T to 50 and varying the noise power σ². All methods show a decrease in test accuracy as σ² increases, due to increased signal distortion from noise. Notably, when σ² exceeds a certain threshold, the test accuracy decreases exponentially. Additionally, both SOBAA-EFO and SOBAA-EFX show little change in WCE, but WAE increases proportionally, leading to a decline in convergence rate and learning performance. However, the SOBAA method according to an embodiment of the present disclosure alleviates this degradation by adopting an appropriate weight factor θ. Furthermore, comparing the test accuracy when σ² is 10⁻⁴ and 1 demonstrated the robustness of the method according to an embodiment of the present disclosure.

When σ² increases from 10⁻⁴ to 1, for the MLP with I.I.D. MNIST, the test accuracy of the SOBAA-EFX according to an embodiment of the present disclosure decreases only by 0.0004, and it can be seen that SOBAA-EFX is more robust than OBDA, EFOBDA, and SOBAA-EFO.

For the 4NN with non-I.I.D. MNIST, the test accuracy of the SOBAA-EFO according to an embodiment of the present disclosure decreases only by 0.003, and it can be seen that SOBAA-EFO is more robust than OBDA and SOBAA-EFX, but a little bit less robust than EFOBDA. For the 5NN with CIFAR-10, the test accuracy of SOBAA-EFO according to an embodiment of the present disclosure decreases only by 0.007, and it can be seen that SOBAA-EFO is more robust than OBDA, EFOBDA, and SOBAA-EFX.

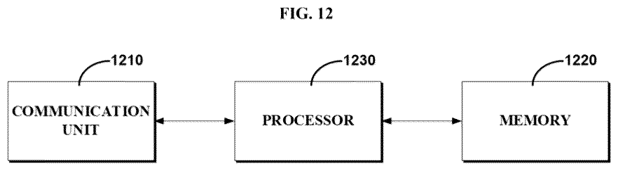

FIG. 12 is a diagram schematically illustrating the internal configuration of a device or server according to an embodiment of the present disclosure.

A device or server according to an embodiment of the present disclosure may comprise a communication unit (1210), a memory (1220), and a processor (1230), respectively.

The communication unit (1210) is a means for transmitting and receiving data with other devices through a communication network.

The memory (1220) stores various instructions for performing a sparse 1-bit quantization-based over-the-air federated learning method according to an embodiment of the present disclosure.

The processor (1230) is a means for controlling the internal components of the device or server (e.g., communication unit (1210), memory (1220), etc.) according to an embodiment of the present disclosure.

Additionally, the processor (1230) can execute the instructions stored in the memory (1220).

In the case of the device, the instructions executed by the processor (1230) may include the following series of processes: receiving the global parameter vector from the server at each communication round t, updating the local parameter vector using the global gradient vector, applying a first-order approximation algorithm using the local dataset based on the global parameter vector to derive the local gradient vector, compressing the local gradient vector by performing 1-bit quantization on each layer, sparsifying the quantized local gradient vector, and then transmitting the sparsified 1-bit quantized local gradient vector to the server through an uplink channel in an analog manner.

On the other hand, in the case of a server, the instructions executed by the processor (1230) may include the following series of processes: determining the amplitude scaling factor and binary sparse masking indicators by considering the loss function and constraints at each communication round, transmitting these to each device, receiving signals from each device, receiving signal, calculating the global gradient vector by correcting the received signal based on the amplitude scaling factors and the sum of all local dataset sizes, and broadcasting the global gradient vector to all devices.

The device and method according to the embodiments of the present disclosure may be implemented in a program that can be executed by various computers and may be recorded on computer-readable media. The computer-readable media may include program commands, data files, and data structures individually or in combinations thereof. The program commands that are recorded on a computer-readable media may be those specifically designed and configured for the present disclosure or may be those known to those engaged in the computer software field and thus available. The computer-readable recording media include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory. The program commands include not only machine language codes compiled by a compiler, but also high-level language code that can be executed by a computer using an interpreter, etc.

The hardware device may be configured to operate as one or more software modules to perform the operation of the present disclosure, and vice versa.

The present disclosure was described above focusing on the embodiments thereof. It would be understood by those skilled in the art that the present disclosure may be implemented in a modified form without departing from the scope of the present disclosure. Therefore, the disclosed embodiments should be considered in terms of explaining, not limiting. The scope of the present disclosure is shown in the claims, not in the above description, and all differences within an equivalent range should be construed as being included in the present disclosure.

What is claimed is:

1. A sparse 1-bit quantization-based over-the-air federated learning method, comprising:
receiving a global parameter vector from a server at each communication round t and updating a local parameter vector using a global gradient vector;
deriving a local gradient vector by applying a first-order approximation algorithm using a local dataset, compressing the local gradient vector through 1-bit quantization for each layer, and then sparsifying the 1-bit quantized local gradient vector; and
transmitting the sparsified 1-bit quantized local gradient vector to the server through an uplink channel in an analog manner,
the server calculates the global gradient vector using a signal aggregated in the air of the sparsified 1-bit quantized local gradient vectors and then broadcasts the global gradient vector to all devices.

2. The sparse 1-bit quantization-based over-the-air federated learning method of claim 1, wherein the step of compressing through 1-bit quantization and then sparsifying for each layer, comprising:
calculating a local gradient vector magnitude scaling factor for each layer; and
calculating the sparsified 1-bit quantized the local gradient vector using the calculated local gradient vector magnitude scaling factor and layer-specific sparse masking indicator.

3. The sparse 1-bit quantization-based over-the-air federated learning method of claim 2, wherein the layer-specific sparse masking indicator is an indicator that determines whether to transmit the layer, and is transmitted from the server in each communication round.

4. The sparse 1-bit quantization-based over-the-air federated learning method of claim 2, wherein layers with a sparse masking indicator of 0 are excluded from transmission.

5. The sparse 1-bit quantization-based over-the-air federated learning method of claim 1, wherein the layer is a layer that composes a deep learning model.

6. The sparse 1-bit quantization-based over-the-air federated learning method of claim 1, wherein deriving the local gradient vector involves calculating a corrected local gradient vector using compression error vector of a previous round.

7. The sparse 1-bit quantization-based over-the-air federated learning method of claim 1, wherein the global gradient vector is calculated by correcting the signal based on amplitude scaling factors and sum of all local dataset sizes.

8. A sparse 1-bit quantization-based over-the-air federated learning method, comprising:
(a) determining an amplitude scaling factor and binary sparse masking indicator by considering a loss function and constraints at each communication round, and transmitting the amplitude scaling factor and binary sparse masking indicator to each device;
(b) receiving a signal, wherein the signal is a signal aggregated in the air of sparsified 1-bit quantized local gradient vectors from each device;
(c) calculating a global gradient vector by correcting the received signal based on the amplitude scaling factors and sum of all local dataset sizes; and
(e) broadcasting the global gradient vector to all devices.

9. The sparse 1-bit quantization-based over-the-air federated learning method of claim 8,
wherein in step of (a), the determining of the amplitude scaling factor and binary sparse masking indicator is performed in parallel, with the binary sparse masking indicator being determined after the amplitude scaling factor is determined.

10. The sparse 1-bit quantization-based over-the-air federated learning method of claim 8,
wherein the sparse masking indicator is an indicator that determines whether to transmit the device.

11. A non-transitory computer-readable recording medium in which a program code for performing the method according to claim 1 is recorded.

12. A device, comprising:
a memory storing at least one command; and
a processor executing commands stored in the memory,
wherein the commands executed by the processor respectively perform:
receiving a global parameter vector from a server at each communication round and updating a local parameter vector using a global gradient vector;
deriving a local gradient vector by applying a first-order approximation algorithm using a local dataset, compressing the local gradient vector through 1-bit quantization for each layer, and then sparsifying the 1-bit quantized local gradient vector; and
transmitting the sparsified 1-bit quantized local gradient vector to the server through an uplink channel in an analog manner,
the server calculates the global gradient vector using a signal aggregated in the air of the sparsified 1-bit quantized local gradient vectors and then broadcasts the global gradient vector to all devices.

13. The device of claim 12,
wherein the step of compressing through 1-bit quantization and then sparsifying for each layer, comprising:
calculating a local gradient vector magnitude scaling factor for each layer; and
calculating the sparsified 1-bit quantized the local gradient vector using the calculated local gradient vector magnitude scaling factor and layer-specific sparse masking indicator.

14. A server, comprising:
a memory storing at least one command; and
a processor executing commands stored in the memory,
wherein the commands executed by the processor respectively perform:
(a) determining an amplitude scaling factor and binary sparse masking indicator by considering a loss function and constraints at each communication round, and transmitting the amplitude scaling factor and binary sparse masking indicator to each device;
(b) receiving a signal, wherein the signal is a signal aggregated in the air of sparsified 1-bit quantized local gradient vectors from each device;
(c) calculating a global gradient vector by correcting the received signal based on the amplitude scaling factors and sum of all local dataset sizes; and
(e) broadcasting the global gradient vector to all devices.
